(19) United States
(12) Patent Application Publication
(10) Pub. No.: US 2013/0236105 A1
(43) Pub. Date: Sep. 12, 2013

(54) METHODS FOR MODIFYING MAP ANALYSIS ARCHITECTURE

(71) Applicants: Hui CHAO, San Jose, CA (US); Behrooz Khorashadi, Mountain View, CA (US); Saumitra Mohan Das, Santa Clara, CA (US)

(72) Inventors: Hui CHAO, San Jose, CA (US); Behrooz Khorashadi, Mountain View, CA (US); Saumitra Mohan Das, Santa Clara, CA (US)

(73) Assignee: QUALCOMM Incorporated, San Diego, CA (US)

(21) Appl. No.: 13/603,877

(22) Filed: Sep. 5, 2012

Related U.S. Application Data
(60) Provisional application No. 61/550,316, filed on Oct. 21, 2011.

(51) Int. Cl. G06K 9/46

(52) U.S. Cl. CPC G06K 9/46
USPC 382/199

(57) ABSTRACT

Apparatuses, methods, systems and computer-readable media for determining a hallway edge and/or room entrance of a map are presented. Embodiments may identify a point of interest (POI) on the map indicative of the room entrance. Embodiments may determine a first edge of the map close to the POI and representative of at least a first wall on the map, and may determine a second edge of the map close to the POI and representative of at least a second wall on the map. Embodiments may then perform a rank analysis of the first edge and second edge based on at least one characteristic of the first edge and one characteristic of the second edge, and may determine the orientation of the room entrance and/or the determine the hallway edge of the POI based at least in part on the rank analysis.

### CROSS REFERENCES

This application claims the benefit of U.S. Provisional Application No. 61/550,316, filed Oct. 21, 2011, titled “METHOD AND/OR APPARATUS FOR CLASSIFYING ELEMENTS OF AN INDOOR AREA,” which is expressly incorporated by reference herein in its entirety and for all purposes. This application is also related to Appln. (Attorney Docket No. 833411(121131U1)), filed on the same day, titled “POI VISIBILITY INFERENCE BASED ON MAP ANALYSIS,” and Appln. (Attorney Docket No. 833411(121131U2)), filed on the same day, titled “METHODS FOR GENERATING VISIBILITY MAPS,” and U.S. Non-Provisional application Ser. No. 13/572,561, filed Aug. 10, 2012, titled “EGRESS BASED MAP REGION CLASSIFICATION,” all of which are expressly incorporated by reference herein in their entirety and for all purposes.

This and any other referenced patents and applications are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

### BACKGROUND OF THE INVENTION

Position location methods and algorithms have become more common place with the growth and improvement in technologies. Many position location methods rely on satellite positioning systems (SPSs), which may include global navigation satellite systems (GNSSs) as a primary source of positioning information. Many methods have been devised to enhance the use of GNSS information, such as employing ground-based base stations to provide assisted global positioning information (e.g. A-GPS). However, more improvements may still be made to positioning technologies. While many methods rely on SPSs, and many may assume that satellite systems must be involved in order to generate accurate position determinations, other positioning methods may be devised that may be substantially different than conventional methods.

### SUMMARY OF THE INVENTION

Apparatuses, methods, systems and computer-readable media for determining a hallway edge and/or room entrance of a map are presented. Embodiments may identify a point of interest (POI) on the map indicative of the room entrance. The POI may be a sign or marking distinguishable visually, such as a storefront sign or a room number on a door. The map may be an overhead map, consistent with a map typically seen in a shopping mall. Alternatively, the map may be a multi-dimensional or 3-dimensional map. Embodiments may determine a first edge of the map close to the POI and representative of at least a first wall on the map, and may determine a second edge of the map substantially close to the POI and representative of at least a second wall on the map. Embodiments may then perform a rank analysis of the first edge and second edge based on at least one characteristic of the first edge and one characteristic of the second edge, and may determine the orientation of the room entrance and/or the determine the hallway edge of the POI based at least in part on the rank analysis.

In some embodiments, the location of the POI may be modified from its original location to a storefront or hallway edge. Some embodiments may determine that the POI is not originally located on a hallway edge. The POI may be originally located in the middle of a room on the map, for example. Some embodiments may compute a vector intersecting the POI and the hallway edge. In some embodiments, the vector may be a normal vector perpendicular to the hallway edge and intersecting the POI. Embodiments may modify the location of the POI to be located at the intersection of the vector and the hallway edge.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A is an indoor facade of a storefront, in perspective view, showing an exemplary environment for uses of embodiments of the present invention.

FIG. 1B is an isometric overhead view of a similar storefront.

FIG. 2A is a view of a hallway within a shopping area with a first store sign, in perspective view, showing an exemplary environment for uses of embodiments of the present invention.

FIG. 2B is a view of a hallways within a shopping area with a second store sign.

FIG. 3A is an overhead map of a mall for exemplary uses with some embodiments.

FIG. 3B is an overhead map of an office for exemplary uses with some embodiments.

FIG. 4 is overhead map view of a zoomed-in portion of an indoor space.

FIG. 5 is a drawing of an overhead map with a first visibility map from a first point of interest.

FIG. 6 is a drawing of an overhead map with a second visibility map from a second point of interest.

FIG. 7 is a drawing of an overhead map showing an area of intersection of the first and second visibility maps.

FIG. 8 is a flowchart for determining a user's location according to various embodiments.

FIGS. 9A-9D are drawings of overhead maps showing possible modifications to visibility maps according to embodiments of the present invention.

FIG. 10 is a flowchart for determining a visibility map according to embodiments of the present invention.

FIGS. 11A-11D are drawings of overhead maps showing methods for determining a hallway edge according to various embodiments.

FIG. 12 is an alternative method for determining hallway edges according to various embodiments.

FIG. 13 is a flowchart for determining a hallway edge according to embodiments.

FIG. 14A-14C are drawings of overhead maps showing methods for modifying the location of a point of interest according to various embodiments.

FIG. 15 is a flowchart for modifying the location of a point of interest according to embodiments.

FIG. 16 is an exemplary computer system according to some embodiments.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

Descriptions herein may refer to “points of interest” or “POIs.” Generally, a point of interest as used herein may be in reference to a particular sign, marking, or location of interest within a surrounding environment. Examples of POIs may include but are not limited to storefront signs, kiosks, advertising signs, office room numbers, name signs on office doors, or other distinguishing marks found in various environments.

Descriptions herein may refer to “visibility maps.” Generally, a visibility map as used herein may be in reference to a map representing at least some area visible to an entity. Conceptually, a visibility map of an entity may be thought of to be based on some or all areas within the line of sight of the entity. Visibility maps may be expressed on a 2-dimensional map, as a colored or highlighted area on the map. Similarly, visibility maps in 3-dimensional space may be expressed as a 3-dimensional construction, limited at least by the line of sight of the entity.

Descriptions herein may refer to a “predefined location.” Generally, this term may mean that a location of the subject being referenced to was already calculated, located, defined, and/or known, and thus a way to express the location quantitatively is also known. For example, if a POI called “X” has a predefined location, it may mean that the location of X is already known and can be identified if need be, e.g. at coordinates (x,y).

Descriptions herein may refer to a “normal vector.” Generally, this term may refer to the conceptual or mathematical meaning commonly associated with a “normal vector.” In other words, a normal vector used herein may refer to a straight line, marking, or arrow pointing in the direction “normal” to, e.g. perpendicular to, a reference line or vector. In 3-dimensional space, a normal vector may mean the “orthogonal vector,” which is the perpendicular analog in 3-dimensions (e.g. a plane) or higher dimensions.

Descriptions herein may also refer to an “intersection.” Generally, this term may refer to the conceptual or mathematical meaning commonly associated with “intersection.” In other words, the intersection of two sets A and B may be the set that contains all elements of A that also belong to, or are common with, B (or vice versa with all elements of B common to A), but no other elements. Similarly, the intersection of three sets A, B, and C may be the set that contains all elements of A that also belong to, or are common with, B and also with C, but no other elements. The intersection of more than three sets may be analogously drawn to the same concepts described herein, but for that number of sets. As used herein, the intersection of just a single set is simply the set itself.

Descriptions herein may also refer to “integrate,” or “integrating,” which may generally be defined as the mathematical Calculus principle of computing an area composed of the sum of rectangles or other similar shapes under or within a curve. Integrating a series of shapes, each with a computed area, may result in a total computed area with a shape comprised of the sum of the individual series of shapes.

Apparatuses, methods, systems and computer-readable media for using visibility maps of identified and/or predefined points of interest (POIs) to determine a user's location are presented. While positioning methods using satellite data to obtain a global positioning fix are well known (e.g. GPS devices, etc.), these methods are constrained by the access to such satellite data, which may not always be available. For example, where a user is well indoors, far away from windows and the edges of buildings (e.g. inside a shopping mall, casino or office building), it is often times very difficult for satellite data to reach the user, and so other methods for determining a user's position may be necessary.

According to embodiments of the present invention, however, the user may determine the user's location by relying on points of interest (POIs) identifiable from the user's visual field of view. These POIs may be easily distinguishable signs, for example signs on storefronts (e.g. Nordstrom or J.C. Penny) or room numbers, where the location of each POI may be predefined and pre-located on an aerial-view type map (e.g. an overhead map of a shopping mall).

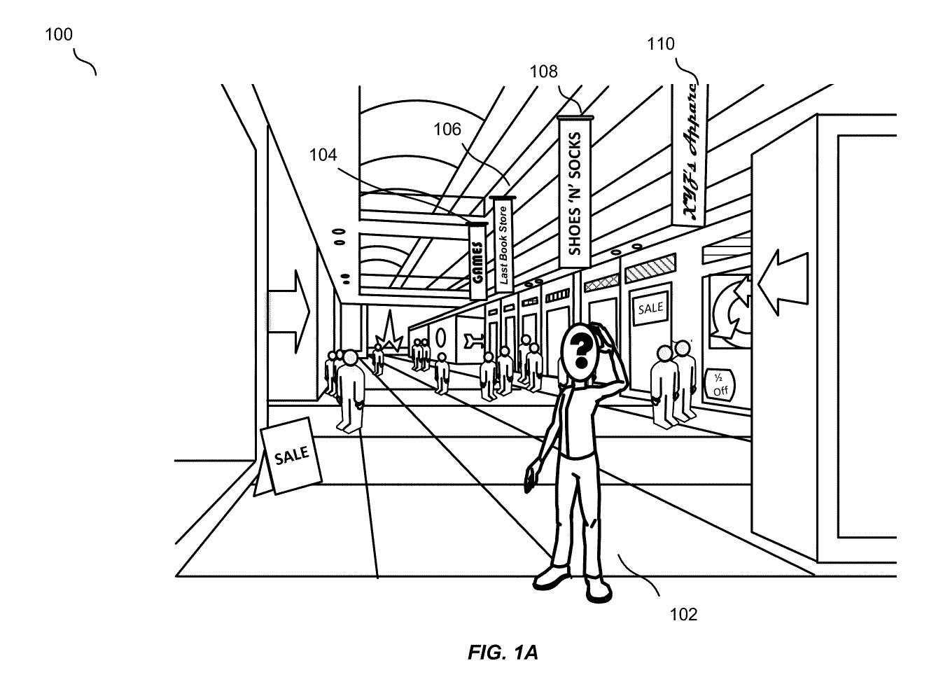

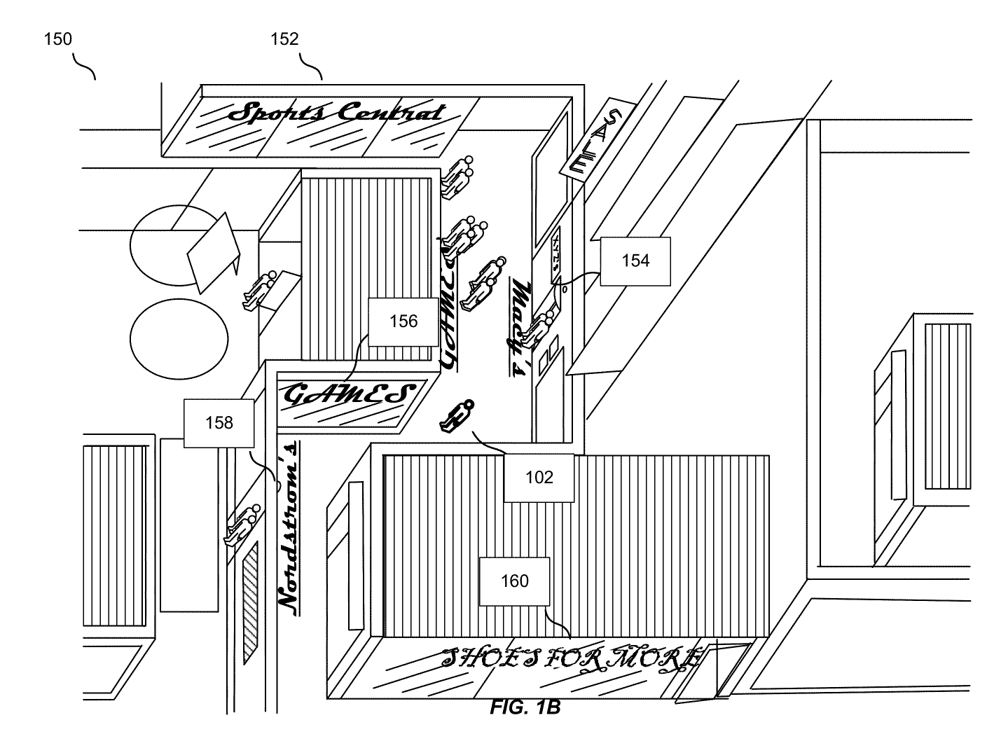

Referring to FIG. 1A, user 102 represents a type of person who may benefit greatly from embodiments of the present invention. User 102 may be standing in shopping mall environment 100 possibly wondering where he is. User 102 may have been so enveloped in his shopping exploits that he has lost his orientation, but would now like to find the exit nearest to his car. User 102 would first like to know where his current location is in the mall, so that he may be able to plot where he needs to travel in order to get to his car. Unfortunately, his mobile device, having global positioning capability, cannot acquire a signal while in the mall, because the indoor environment impedes the satellite signals and the assisted-global positioning signals from local terrestrial base stations. User 102 therefore is unable to rely on traditional wireless global positioning techniques, such as GPS tracking or A-GPS methods. However, user 102 does see a number of storefront signs, such as signs 104, 106, 108, and 110. These may be useful positioning clues, as only certain locations in the mall are able to see all of these signs from the same location. Given the unique nature of signs 104, 106, 108, and 110, these signs may also be called “points of interest,” or “POIs.” These POIs have a predefined and/or pre-located position, in that they remain fixed in front of their respective stores. Other examples of POIs may include access points to wired or wireless networks and the centers of entrances to stores or rooms. Therefore, the exact locations of POIs 104, 106, 108, and 110, for example, may be already known, with position coordinates stored in a database.

Referring to FIG. 1B, isometric overhead view 150 illustrates a different perspective of where user 102 may be within the shopping mall. User 102 stands within a veritable labyrinth of stores, corridors, and/or hallways. User 102 may be able to see the various storefront signs, such as “Sports Central” sign 152, “Macy's™” sign 154, “Games” sign 156, and “Nordstrom™” sign 158. User 102 may not be able to see “Shoes for More” sign 160, from where he currently stands. Given the types of storefront signs user 102 can see at his present location, one may be able to deduce that user 102 is located only within a particular confined location: a location that is within line of sight of all signs 152, 154, 156, and 158. Similar to FIG. 1A, signs 152, 154, 156, and 158 may also be referred to as POIs, having predefined and/or pre-located positions determined and stored in a database.

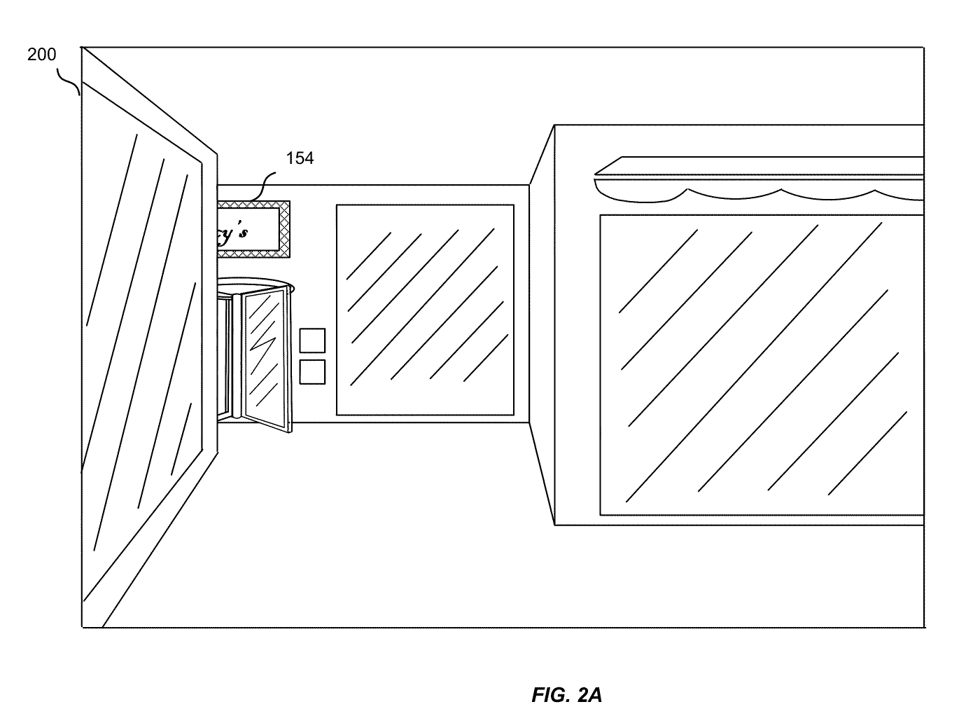

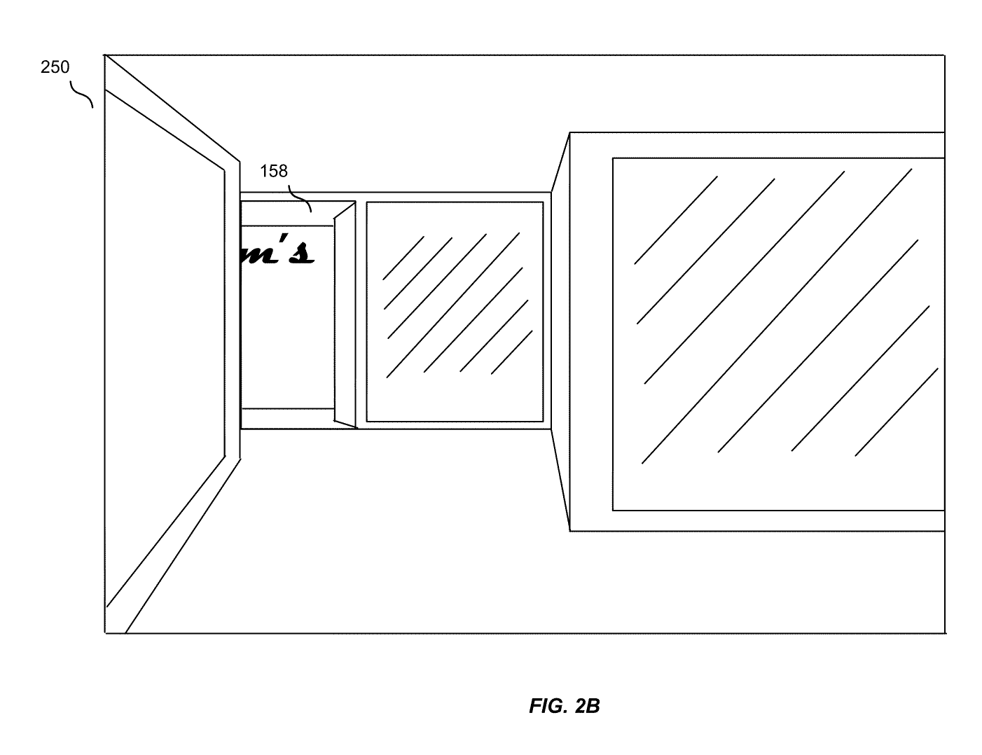

Referring to FIG. 2A, the perspective view 200 illustrates a view of what user 102 may see with his own eyes, standing within the shopping mall. Here, user 102 is able to see a partial view of the POI “Macy's™” sign 154. Other signs, windows, and/or objects may also be visible, but are not highlighted for purposes of this disclosure.

Referring to FIG. 2B, the perspective view 250 illustrate a view of what user 102 may see at the same location as in FIG. 2A, but with his view oriented in a different angle, e.g. a 90 degrees shift. Thus, turning the user's 102 head to face a different direction in the shopping mall, user 102 may be able to see a partial view of the POI “Nordstrom™” sign 158. Other signs, windows, and/or objects may also be visible, but are not highlighted for purposes of this disclosure.

Based on just the knowledge of the two POIs of “Macy's™” 154 and “Nordstrom™” 158, the possible location of user 102 may be drastically narrowed. This is because there may be only a limited area within the shopping mall capable of viewing both POIs 154 and 158 at the same time. For example, if user 102 walks closer to the “Macy's™” sign 154, user 102 may lose sight of the “Nordstrom™” sign 158 due to a wall or corner blocking the view. Conversely, if user 102 walks closer to the “Nordstrom™” sign 158, user 102 may lose sight of the “Macy's™” sign 154. Thus, user 102 may be determined to be located just within a particular area visible to both POIs 154 and 158.

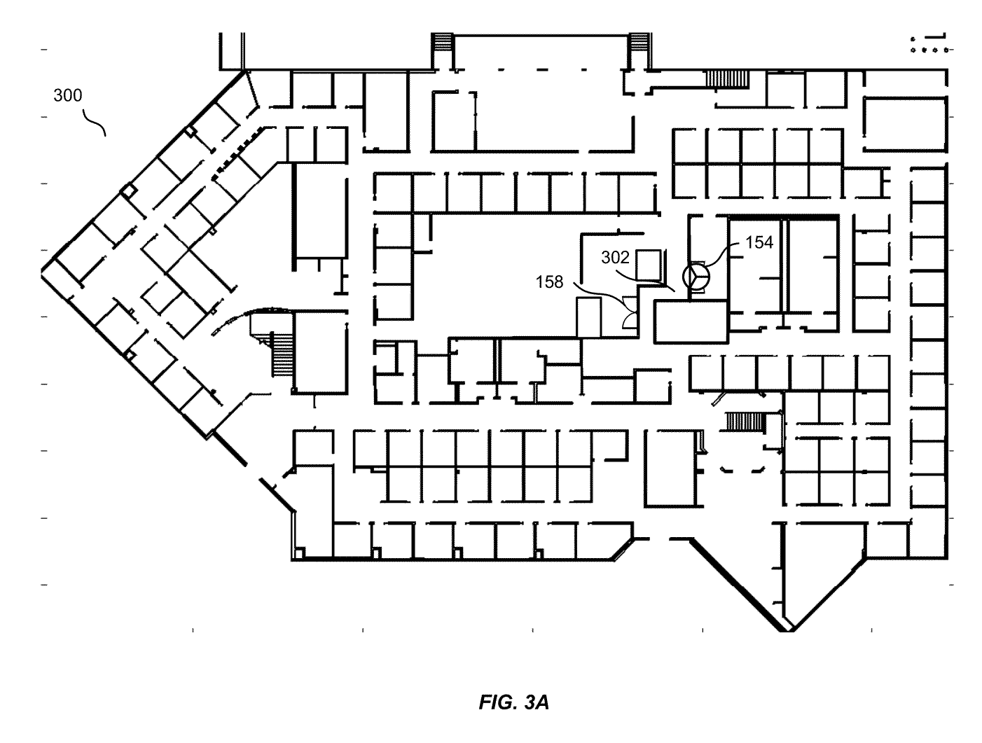

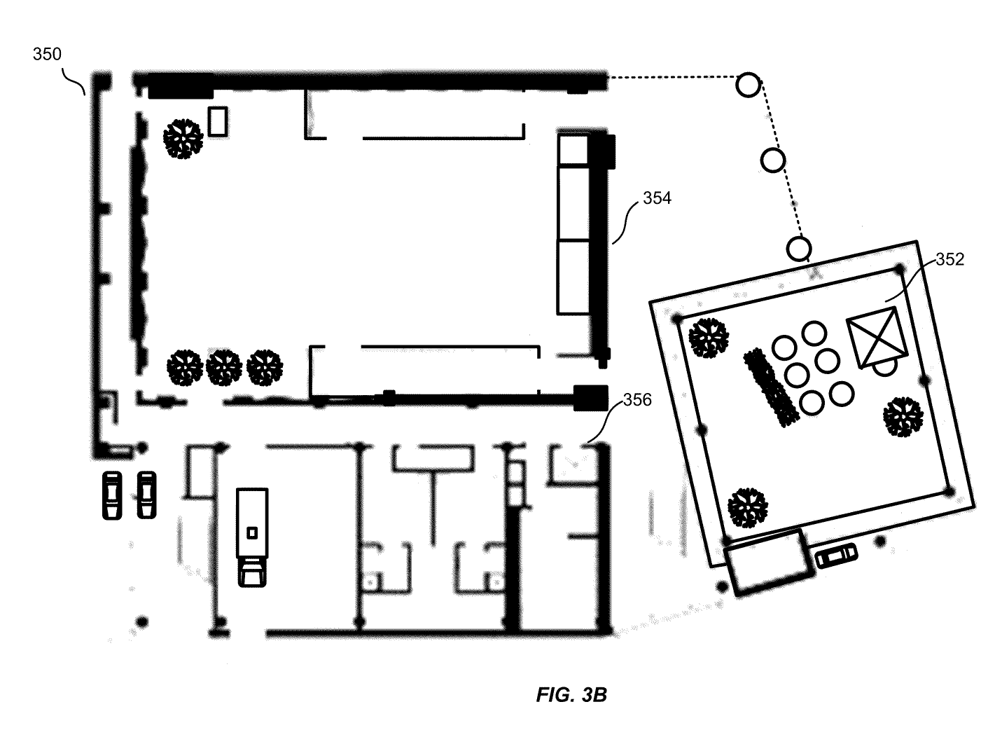

Referring to FIG. 3A, overhead map 300 represents an aerial view of the indoor space of a building, for example a shopping mall or an office building. Corridor 302 may represent the perspective views shown in FIGS. 2A and 2B, with POIs 154 and 158 being shown near to the corridor where user 102 may be currently located. As discussed above, user 102 may be able to determine his location to within a fairly narrow limit, just by knowing he is able to view both POIs 154 and 158 while remaining at his current position. Specifically, user 102 can determine that he must be somewhere within corridor 302, which seems to be the only space capable of viewing both POIs 154 and 158 from the same location.

Overhead map 300 therefore demonstrates the notion that even with knowledge of just 2 POIs within the line of sight of a user 102 (i.e. POIs 154 and 158), the user 102 can narrow the determination of his location apart from every other room, corridor, hallway, and/or stairway of map 300. These principles guide embodiments of the present invention.

Referring to FIG. 3B, overhead map 350 represents an aerial view of another building or structure, such as a small office, restaurant or a house. The same principles mentioned in FIGS. 1A through 3A may similarly apply to determine a user's location within the premises shown in map 350. User 102 may now be located somewhere within the structure 350, and from his position can see POI 352: a gazebo, POI 354: a sign of the building, and POI 356: a counter top. Having identified these POIs and knowing the user 102 must be located where he can see each of the three POIs from the same position, the exact location of the user 102 is narrowed to only a limited area on the premises 350.

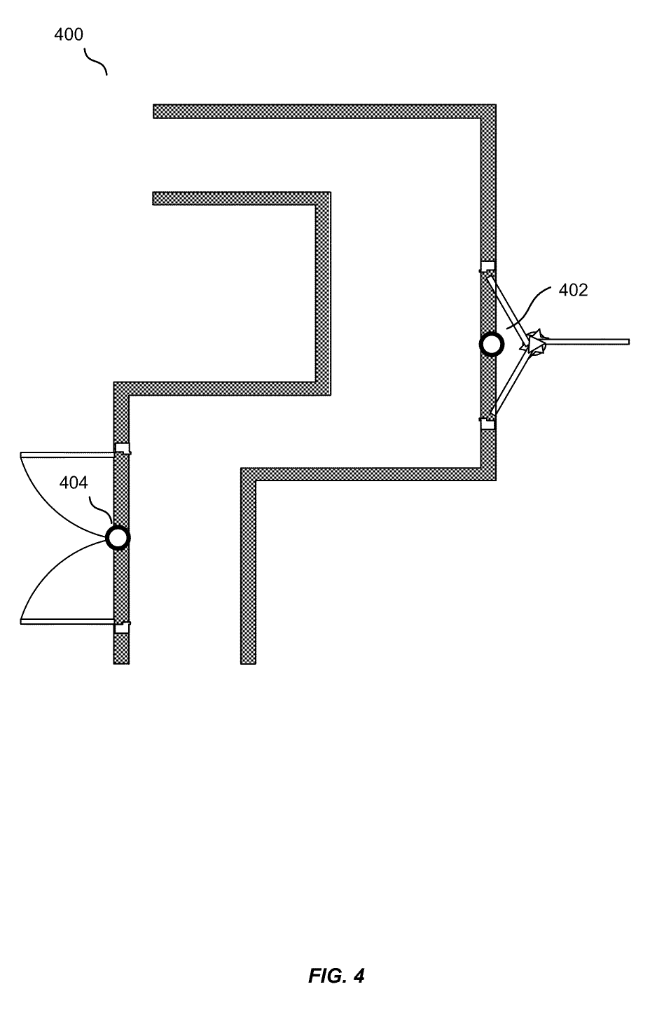

Referring to FIG. 4, embodiments for determining the user's location may employ the follow techniques for determining a user's location, described herein. Overhead map 400 represents the section of the shopping mall where user 102 was lost. Recall the POIs of the “Macys” and “Nordstrom” signs are visible within user 102's line of sight. POI 402 is designated as the location of the “Macys” storefront sign, while POI 404 is designated as the location of the Nordstrom storefront sign. User 102 may identify with a mobile device, such as a cell phone with a camera, POIs 402 and 404 from his location. Such identification may be achieved by image recognition of the storefront signs, via a camera and image recognition software. Alternatively, the Macys and Nordstrom signs may have installed sensors with unique signatures or serial numbers that can be received by/transmitted to a mobile device. Any number of ways apparent to people with ordinary skill in the art may be used by user 102 to obtain recognition that POIs 402 and 404 are within his field of view, and embodiments are not so limited.

Recall that each POI may have a predefined location on an overhead map. This means that the location of the POI may be already known, at least within the confines of the overhead map. The predefined locations of the POIs may be determined a priori via GPS positioning for an absolute positioning, or may be measured on a relative scale on an overhead map of the entire building. Any variants of these methods for determining the absolute or relative location of POIs may be valid, and are not limiting. For example, the POIs identified by the user 102 are capable of having a predefined location. Thus, user 102 may be able to determine his own location through the knowledge of the locations of the POIs.

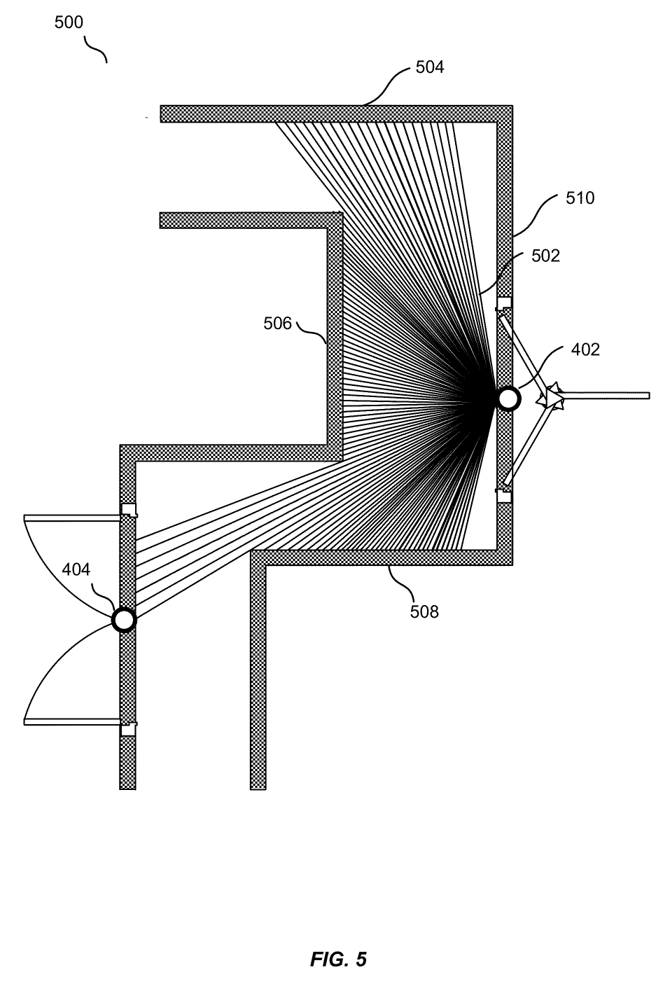

Referring to FIG. 5, having determined that POIs 402 and 404 are within the user's field of view, embodiments may then determine the user's location using “visibility maps” of the POIs, described herein. A logical principle that may be helpful to understanding embodiments of the present invention, is the idea that objects a user can view, conversely, can also “view” the user. Applying this principle, it means that if the user 102 is able to view POIs 402 and 404, then both POIs 402 and 404 are able to “see” user 102. Thus, areas common to where both POIs 402 and 404 can “see” are where the user 102 must be located.

From this basis, a “visibility map” of POI 402, or an area visible within the line of sight of POI 402, is calculated. Still referring to FIG. 5, many lines 502 connecting to POI 402 and ending at walls 504, 506, etc., are shown. One may interpret these rays or lines 502 emanating from POI 402 to represent lines of sight of POI 402. That is, the rays 502 may start from POI 402, travel in a straight line and end at opaque barriers, like walls 504, 506, etc. In other words, the area covered by the lines 502 may represent the area within a line of sight of POI 402. Another way of conceptualizing the area within a line of sight of a POI is to, for example, start from the “first person” point of view of POI 402, then perform a visual “sweep” from one side (e.g. the left side) to the other side (e.g. the right side). Everything within view of this visual “sweep” may represent the area within a line of sight of the POI 402. This area for which the rays 502 cover/encompass may be thought of as the “visibility map” 502 of POI 402. It should be apparent that the visibility map 502 may not typically have a symmetrical or elegant looking shape, but rather may be based largely on the linear lines of sight emanating from POI 402, and ending at opaque objects, such as the walls 504, 506 and 508. If physical constructs are transparent or translucent, such as a window or stained glass panes, a visibility map may take these into account and expand through these physical barriers, thus enlarging the visibility map of that POI. Also, while the lines 502 emanating from POI 402 are distinct and finite in FIG. 5, in reality, the area formed by the lines of sight emanating from POI 402 are contiguous in nature, and the depiction in FIG. 5 is merely an approximation for purposes of illustration.

Since user 102 is able to see POI 402, it can be reasoned that user 102 must be somewhere within the visibility map 502 of POI 402, based again on the principle that an object of what a user can view, conversely, can also “view” the user.

Furthermore, visibility maps generally have a context based on an overhead map and a POI. In other words, generation of visibility maps typically relies on pre-existing knowledge of an overhead map, such as those shown in FIG. 3A or 3B, the lines on the overhead map representing opaque barriers, e.g. walls of the building, and the predefined location of the POI in question. Certainly, visibility maps do not need all of these constraints, but lacking such constraints may make a visibility map less accurate. This also suggests that visibility maps can also be predefined and pre-located, for every predefined POI, before a user ever needs to access or obtain such a visibility map. Thus, in some embodiments, visibility maps are simply obtained, because the visibility maps have already been generated. In other embodiments, visibility maps are generated in real time.

It can also be seen in FIG. 5 that the visibility map 502, as shown, does not include the lines of sight from the very steepest angles emanating from POI 402. Visibility maps may include all angles within 180 degrees of a POI, or even all 360 degrees, with the rays ending only at opaque barriers. However, other visibility maps may be further narrowed based on the idea that a user 102 would not be able to view POI 402 if he stands within the areas at the steepest angles from POI 402. Since POI 402 is actually representative of a flat storefront sign, e.g. a Macy's™ sign, it can be reasoned that the flat sign may not be visible just along the walls that the storefront sign 402 resides on. Therefore, if user 102 cannot see POI 402 at those areas, then POI 402 should not be able to “see” the user 102, and thus the visibility map illustrated in FIG. 5 is shown to reflect that.

As just mentioned, it can also be seen that visibility map 502 includes only areas within the hallway region, and therefore does not include areas within the store of Macy's™, e.g. to the right of wall 510, not shown. Visibility maps may include the spaces within a room or store area, not just within the outside hallway. Other times, however, POI 402, being a storefront sign, may not actually be visible from inside the store, since it may be located above the door and facing outward and be blocked from view by the wall above the door. In other cases, visibility maps may be purposely limited to display regions pertaining only to a certain kind of area, e.g. the hallway area, as opposed to inside the stores. This is because a user may already be able to identify his location while in a store (e.g. he is in the store of Macys!), so that there may be no need to consider visibility map areas within a store. In other cases, visibility maps may be associated with an angle or a range of angles, e.g. at 45 degree and/or with ±5 degree from the normal. In other cases, a user location may be refined to a smaller possible region. Furthermore, it may be determined that in the vast majority of cases, a second POI, such as POI 404, cannot be visible from within rooms or stores, and thus expanding visibility maps to include more than just a hallway region may be superfluous. Nevertheless, such constraints described herein do not limit embodiments of the present invention.

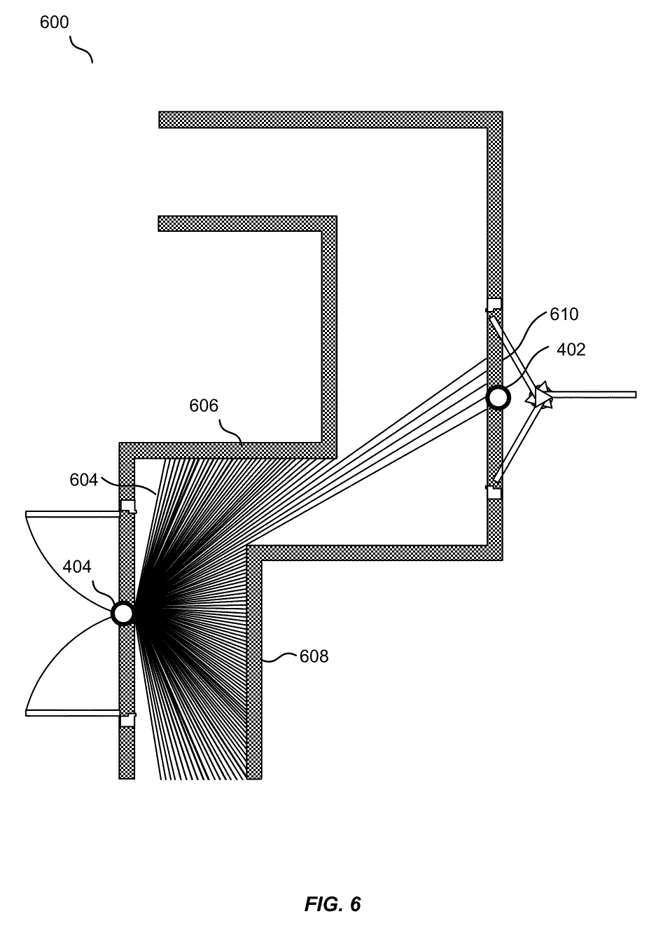

Next, referring to FIG. 6, a second visibility map 604, for POI 404, may be generated or obtained, and having a shape as shown. Like in FIG. 5, the visibility map 604 of POI 404 represents the lines of sight emanating from POI 404 into the hallway region. It can be seen again that the visibility map 604 has a shape based on the linear lines of sight from POI 404, and ending at opaque barriers, such as walls 606, 608, and 610. Here, the bottom of overhead map 600 is not extended, but one can imagine that a more complete visibility map would include the rays emanating further down the hallway from POI 404, not shown. However, the area down the hallway from POI 404 is not shown for purposes of illustration here, because that region clearly is not viewable from POI 402 as well, and this illustration focuses mainly to demonstrating how a user's location can be determined given both POIs 402 and 404 are visible from the user's 102 location.

Since user 102 is able to see POI 404, it can be reasoned that user 102 must be somewhere within the visibility map 604 of POI 404, based again on the principle that an object of what a user can view, conversely, can also “view” the user.

It can also be seen, like in FIG. 5, that the visibility map 604 does not include lines of sight at the steepest angles from POI 404. The rationale for such may be according to what is described above, in FIG. 5. Visibility maps are not limited to such a constraint, and may include such steep angles, areas encompassing up to 360 degrees around a POI, or be limited to substantially less (e.g. less than 90 degrees in total). Embodiments are not so limited.

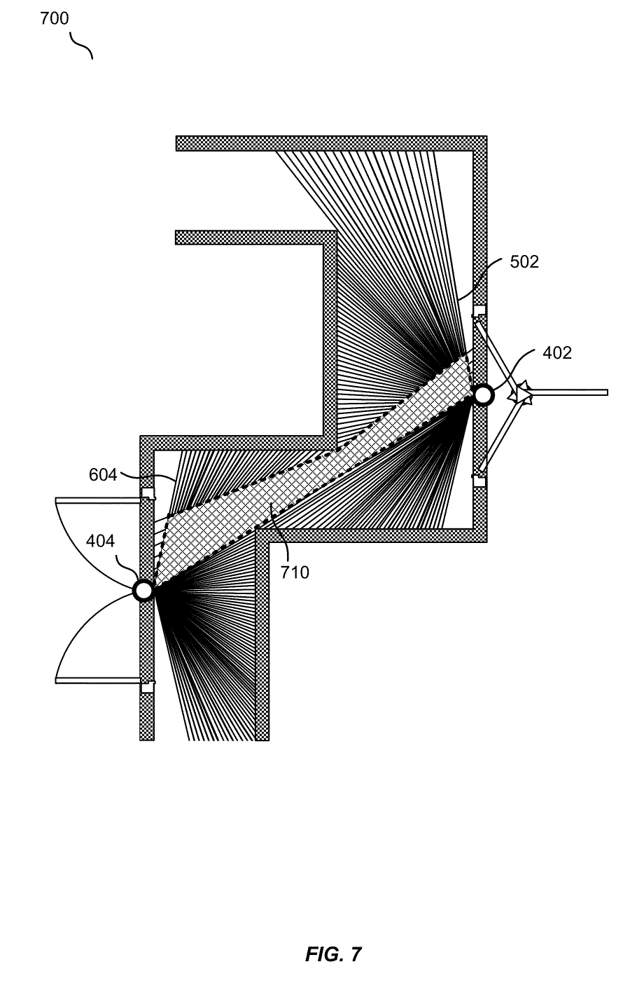

Finally, referring to FIG. 7, since it is known that user 102 must be within both visibility map 502 and visibility map 604, then it can be reasoned that user 102 is within the area common to both visibility maps 502 and 604. In other words, computing the intersection of visibility maps 502 and 604 determines the location of user 102. For illustration, both visibility maps 502 and 604 are displayed, and their overlay can be seen. The area common to both, e.g. their intersection 710, is represented as the criss-crossed region. This region 710 represents where the user must be, and is therefore defined as the determined location of the user. As can be seen, the intersection of even two POIs results in a drastically smaller region where a user may be located.

The area where user 102 may be located may be further refined with additional techniques according to embodiments of the present invention. For example, sensors and/or cameras at or around the POIs may be configured to measure an angle or a distance from the POI to the user's 102 receiver. The user may determine the angle by comparing the detected storefront sign in a camera image with a standard storefront sign. The user may also determine the angle based on vanishing points of edge line features around the storefront in the camera image. To determine a distance, the user 102 may send a signal that measures round trip time from his receiver to a POI and back, and determine the distance assuming a known rate of travel. The round trip signal could be a ping message or a radar signal, for example. Alternatively, each POI may be configured with a stereo camera, or the user's 102 receiver could be configured with a stereo camera, allowing a distance to be measured between the POI and receiver. Even one distance measurement, after having already determined the area of intersection, may drastically refine determination of the user's 102 location.

Additionally, the angles at which the lines of sight emanate from POIs may be widened or narrowed, thereby modifying the shape of visibility maps, which in turn may change the area of intersection. The angles may be modified in order to more accurately reflect where a user 102 may actually be able to identify POIs. For example, a sensor representing a location of a POI may be configured to be detectable only at certain angles relative to the POI, e.g. 70 degrees both to the left and right of center of the sensor. At steeper angles, the sensor may be undetectable. Therefore, a visibility map of such a POI should be drawn only within 70 degrees both to the left and right of center, and not a full 90 degrees to the left and right of center (i.e. 180 degrees). Again, the possible angle at which the user 102 observes a POI may be estimated consistent with what is described above or similarly according to techniques known in the art.

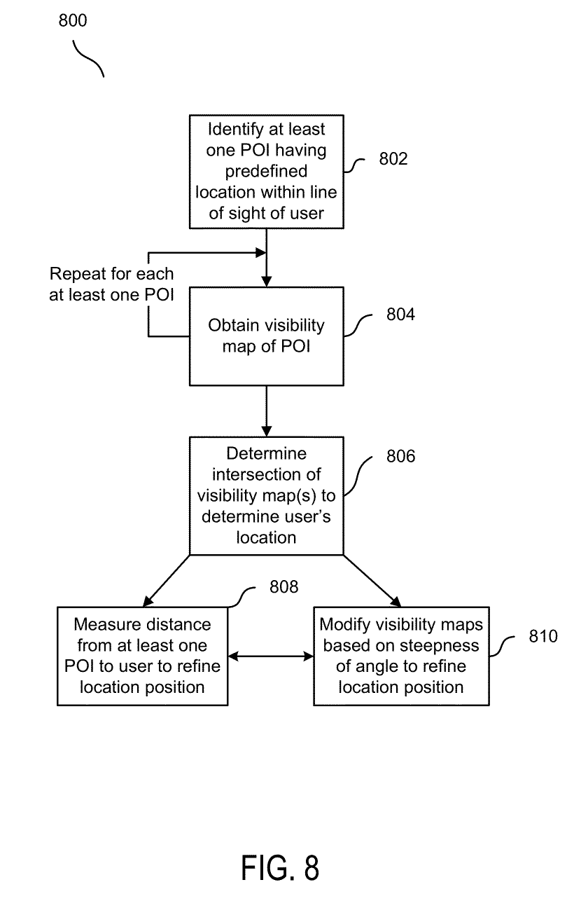

Referring to FIG. 8, flowchart 800 represents exemplary method steps for implementing some embodiments. These method steps may correspond to the processes described in FIGS. 1A to 7. Specifically, starting at block 802, a user, such as user 102, may identify at least one POI having a predefined location on a map that is within a line of sight of the user 102. The map may be an overhead, 2 dimensional map, not unlike maps traditionally seen in mall kiosks. The map may also be a 3-dimensional map, containing multiple floors or levels. At block 804, a visibility map may be obtained for each of the at least one POIs. The visibility maps may be generated beforehand, and may be stored on a server which can then be downloaded. Alternatively, visibility maps may be generated by embodiments of the present invention. At block 806, a user's location may be determined based on determining the intersection of each of the visibility maps for each of the at least one POIs. In the cases where only one visibility map is used in some embodiments, the intersection of just one visibility map is defined herein to be just the visibility map itself.

Some embodiments may be completed at block 806, but other embodiments may refine the position of the user 102 by following block 808 or 810, or both blocks 808 and 810. At block 808, a distance from at least one of the identified POIs to the user and/or user's receiver may be measured. Thus, the user's position may be further refined by determining all locations within the intersection of the visibility maps that are the measured distance away from the identified POI. The distance may be measured through multiple means, such as via stereo camera of the user's receiver, stereo camera of a camera or sensor associated with the identified POI, round trip time or distance measurement, e.g. ping measurement or radar signal, and the like. Embodiments are not so limited, and other techniques apparent to persons with ordinary skill in the art are also valid. Alternatively, or in addition, at block 810 the user's position may be further refined by modifying visibility maps based on a steepness of the angle from the wall that the POI resides on. A remote server may determine such an angle, or the user's receiver or mobile device may perform the calculation. Other techniques for modifying visibility maps based on the steepness of the angle relative to the wall may be apparent to persons with ordinary skill in the art, and embodiments are not so limited. The intersection of the visibility maps may then be recalculated and possibly refined, based on the modified visibility map. Certainly, any and/or all visibility maps may be further refined in this way, and embodiments are not so limited.

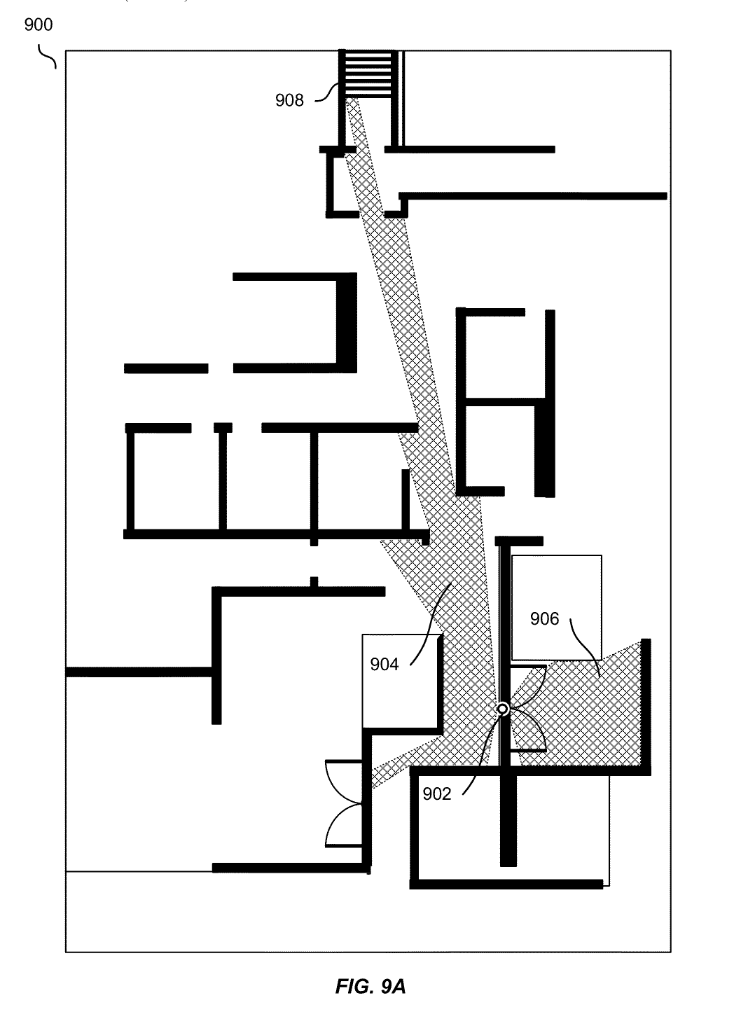

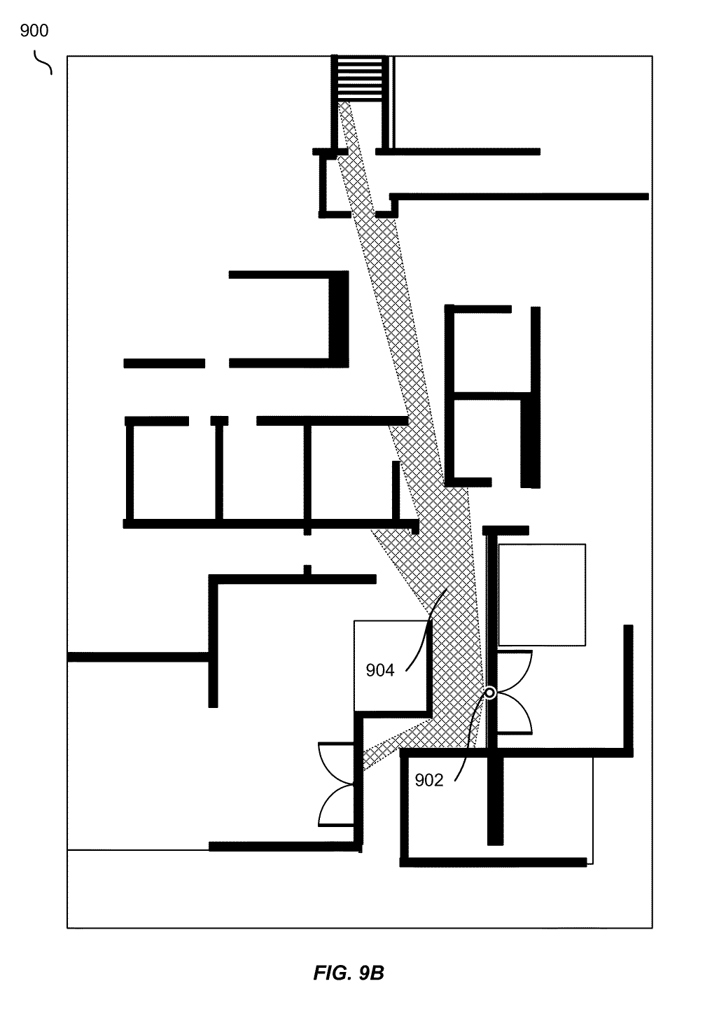

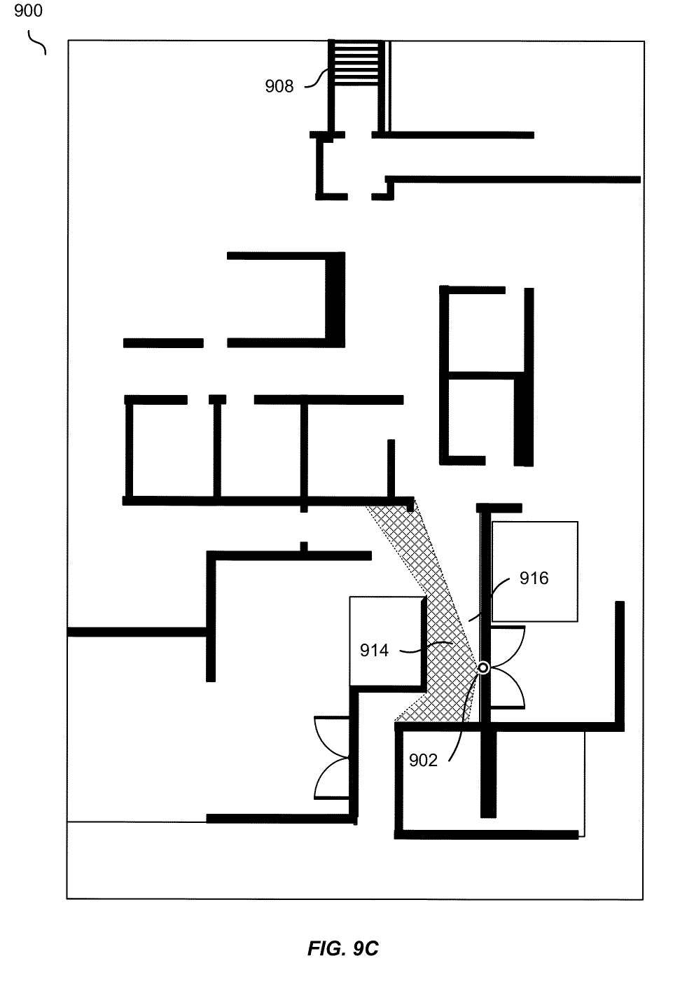

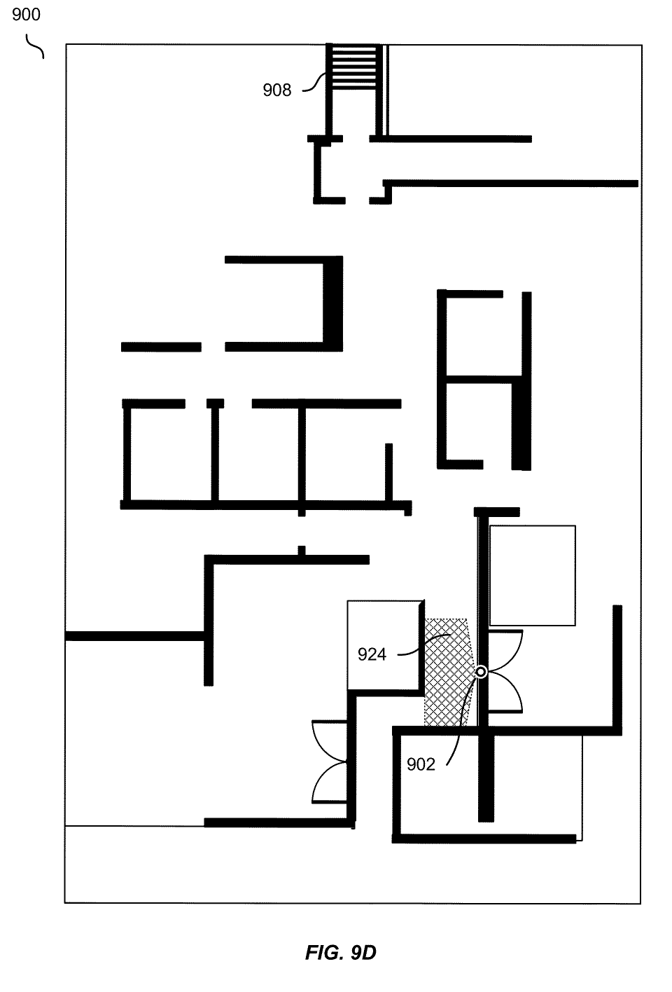

Referring to FIG. 9A, visibility maps may be further narrowed according to some embodiments. One purpose of such narrowing may be to reduce computations and/or time that may be required prior to determining an intersection of multiple visibility maps to save power and/or computational time. Visibility maps may be justifiably narrowed because it may be determined that a user is not within certain areas of a visibility map, even though the visibility map technically reaches out to those areas. Examples may be illustrated in the following figures.

Still referring to FIG. 9A, overhead map 900 may represent a section of an office building or shopping mall. POI 902 may generate the visibility map highlighted by the meshed area, i.e. meshed areas 904 and 906. The visibility map of POI 902 may be generated by computing the area spanning lines of sight emanating from POI 902, where the lines of sight end at opaque barriers such as walls, as shown in map 900. Here, area 904 may extend all the way across a long hallway corridor to stairwell 908, due to the fact that a small area near stairwell 908 is within the line of sight of POI 902. Area 906 may also be part of the visibility map of POI 902, noting that area 906 is within a room of map 900 and not a hallway region.

Referring to FIG. 9B, the visibility map of POI 902 may be narrowed, reduced or limited. Here, area 906, not shown, may be eliminated as part of the visibility map of POI 902. Embodiments may reduce the visibility map as such because POI 902 may be viewable only from the outside of a room, and the visibility map may thus need to be modified with this additional constraint. Another reason for eliminating area 906 may be that it is determined that a user categorically cannot see other POIs from inside a room, and thus including areas inside rooms may waste computational resources and/or time. Also, some embodiments may simply be limited to computing a user's position while in hallway regions as opposed to rooms. Other reasons may be apparent to persons with ordinary skill in that art, and embodiments are not so limited.

Referring to FIG. 9C, the visibility map of POI 902 may be further narrowed by changing the angle of area comprising lines of sight emanating from POI 902. Here, area 914 is a modified visibility map, compared to area 904, not shown, due to the angle 916 being enlarged. Angle 916 may represent an angle from POI 902 of which lines of sight emanating from POI 902 are not included as part of the visibility map 914 of POI 902. Embodiments may reduce the visibility map as such because a user may not be able to actually see POI 902 when standing at such an angle, such as within angle 916. Alternatively, a user may be unable to detect or identify POI 902, possibly due to some implementations of some embodiments, while at such angles from POI 902, such as within angle 916. Other reasons may be apparent to persons with ordinary skill in that art, and embodiments are not so limited. Therefore, it may be desirable to modify the visibility map accordingly. In this case, it may be apparent that visibility map 914 no longer includes areas near stairwell 908, confirming that the visibility map has been reduced compared to the visibility map shown in FIG. 9A.

Referring to FIG. 9D, the visibility map of POI 902 may be further narrowed by adjusting for a relative distance away from POI 902. For example, while a visibility map of POI 902 may be technically constructed to include some areas near stairwell 908—due simply to POI 902 being within a line of sight from some areas near stairwell 908—the actual distance from POI 902 to stairwell 908 may be very long, and thus a user may not be able to identify POI 902 with clarity from such a distance. Accordingly, embodiments may reduce visibility map 924 to include only areas within a line of sight of POI 902 and also constrained by some threshold distance from POI 902 representative of some distance within which POI 902 is actually or practically viewable/identifiable. In other words, the lines of sight emanating from POI 902 may be truncated such that the lines of sight are not longer than a predetermined threshold. In this example, visibility map 924 illustrates just a relatively small area, in relatively close proximity to POI 902 and may be generated by such principles explained herein. Visibility map 924 may be increased in size, depending on the length of the threshold distance, and embodiments are not so limited.

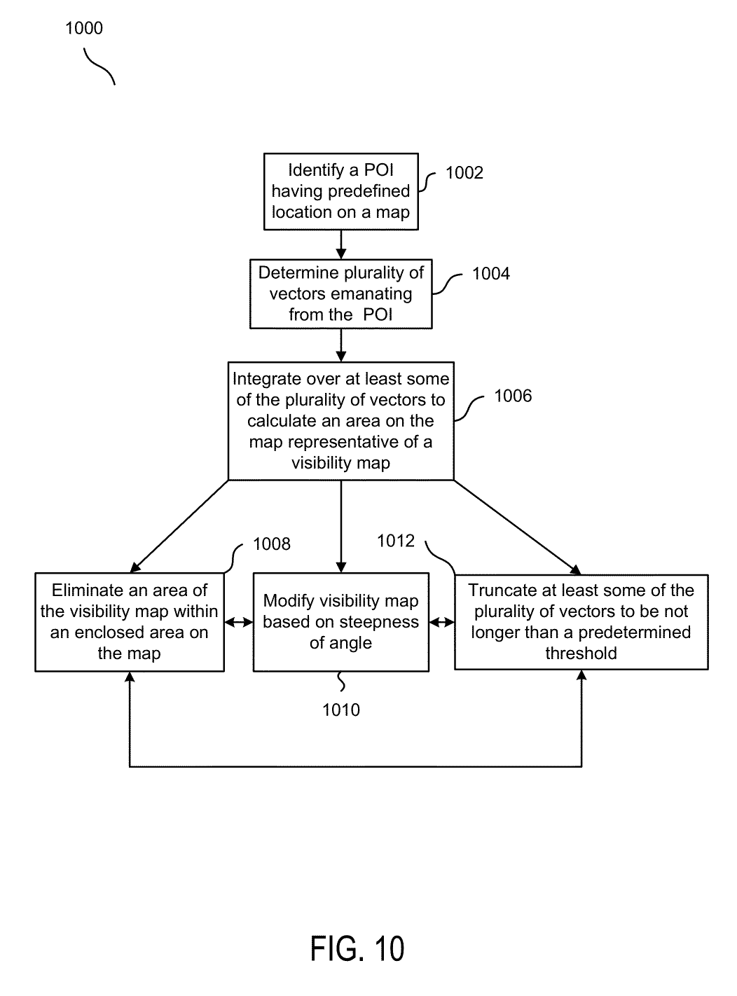

Referring to FIG. 10, flowchart 1000 represents exemplary method steps of some embodiments related to generating visibility maps. Flowchart 1000 may be implemented by any number of devices or apparatuses, including but not limited to mobile devices, computer servers, remote terminals, base stations, and position-determining entities. At block 1002, an exemplary method first identifies a POI, e.g. POI 902, not shown, having a predefined location on a map. Any of the POIs mentioned in the present disclosure may suffice, though embodiments are not so limited. The POI may be pre-located on a map such as an overhead map shown in any of the figures of the present disclosure, but embodiments are not so limited. Alternatively, the map may be a 3-dimensional map, illustrating locations in spatial dimensions or at least in multiple levels.

At block 1004, the exemplary method determines a plurality of vectors emanating from the POI. These vectors may represent lines of sight emanating from the POI, according to the map, and ending at opaque barriers as defined on the map. The vectors may additionally including other behaviors if it is known there are transparent or translucent barriers shown on the map. The plurality of vectors may be some or all lines of sight emanating from the POI in some or all directions, consistent with any of the descriptions of the present disclosure, though embodiments are not so limited.

At block 1006, the exemplary method integrates over at least some of the plurality of vectors from block 1004 to calculate an area on the map representative of a visibility map. To illustrate the concept of integration as used herein, referencing FIG. 5 for example, within each of two lines of sight emanating from POI 402, as shown, there is a triangle-shaped area of space on the map 500. Each of these triangle-shaped areas may be highlighted, their area computed, and then summed together to generate the visibility map 502. The area of integration representative of a visibility map may include some or all of the vectors emanating from the POI, and embodiments are not so limited.

Referring to block 1008, some embodiments may further refine or modify a visibility map of a POI by eliminating an area of the visibility map with an enclosed area on the map. In other words, some of the originally computed area representative of the visibility map, as computed in block 1006, may be removed or eliminated to create a smaller visibility map. For example, referring to FIG. 9B, the area computed within the room, to the right of POI 902, may be removed or eliminated such that only the area representative of lines of sight into the hallway areas of POI 902 are included in the visibility map 904 of POI 902. While some embodiments may include block 1008, it is not necessary to do so, and embodiments are not so limited either way.

Referring to block 1010, some embodiments may further refine or modify a visibility map of a POI based on a steepness of an angle from the POI. For example, referring to FIG. 9C, the area of integration from the POI 902 may be modified to not include the lines of sight from POI 902 inclusive within angle 916. Depending on the steepness of angle 916, for example, the visibility map 914 may be appropriately modified. While some embodiments may include block 1010, it is not necessary to do so, and embodiments are not so limited either way.

Referring to block 1012, some embodiments may further refine or modify a visibility map by truncating at least some of the plurality of vectors to be not longer than a predetermined threshold. For example, referring to FIG. 9D, while the lines of sight emanating from POI 902 may normally end at opaque barriers, they may instead be limited by a predetermined threshold, resulting in a smaller visibility map 924. The predetermined threshold may represent a distance away from POI 902, which may be representative of a user's or camera's inability to clearly identify objects from a far enough distance. Block 1012 may also include methods involving visibility maps truncated by a uniform radius threshold distance around a POI. Other valid examples may be apparent to persons having ordinary skill in the art. While some embodiments may include block 1012, it is not necessary to do so, and embodiments are not so limited either way.

The arrows in flowchart 1000 may illustrate that embodiments may include any or all of block 1008, 1010, and 1012, and may be performed in any combination.

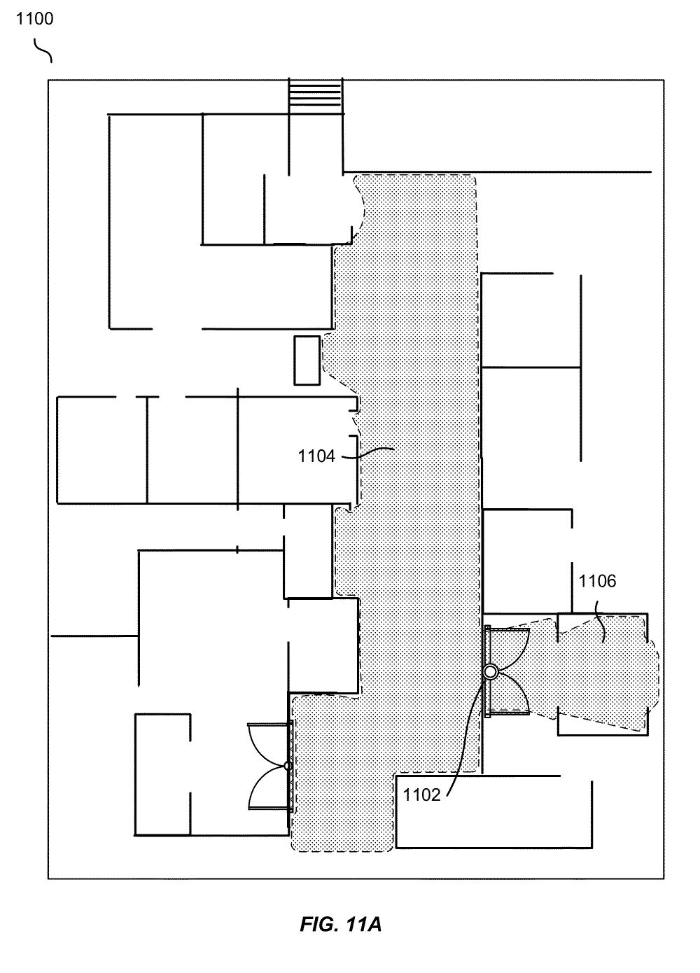

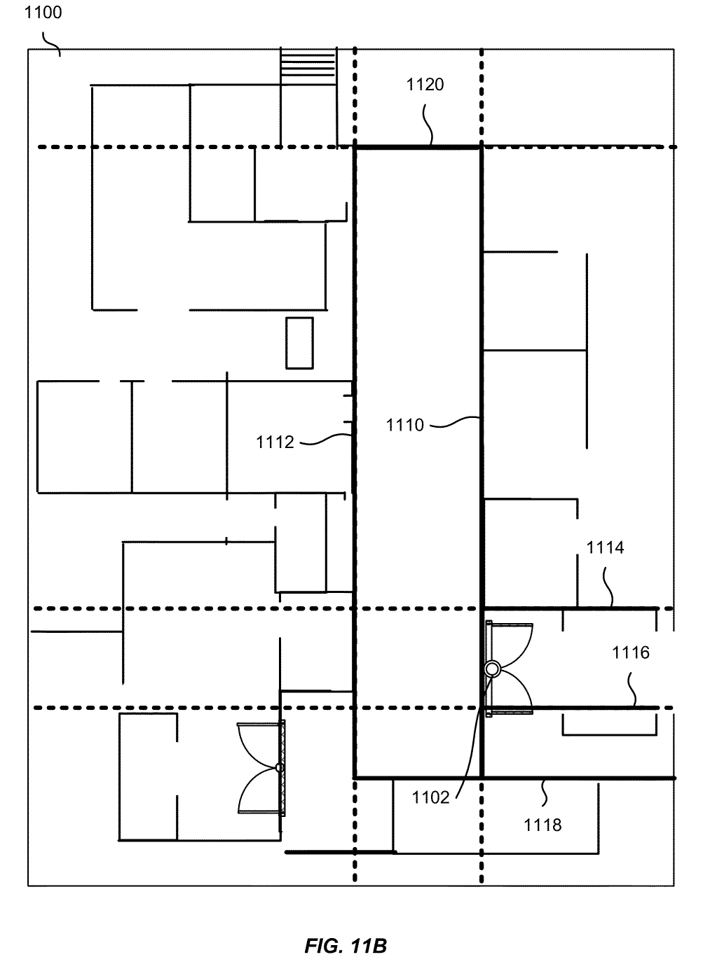

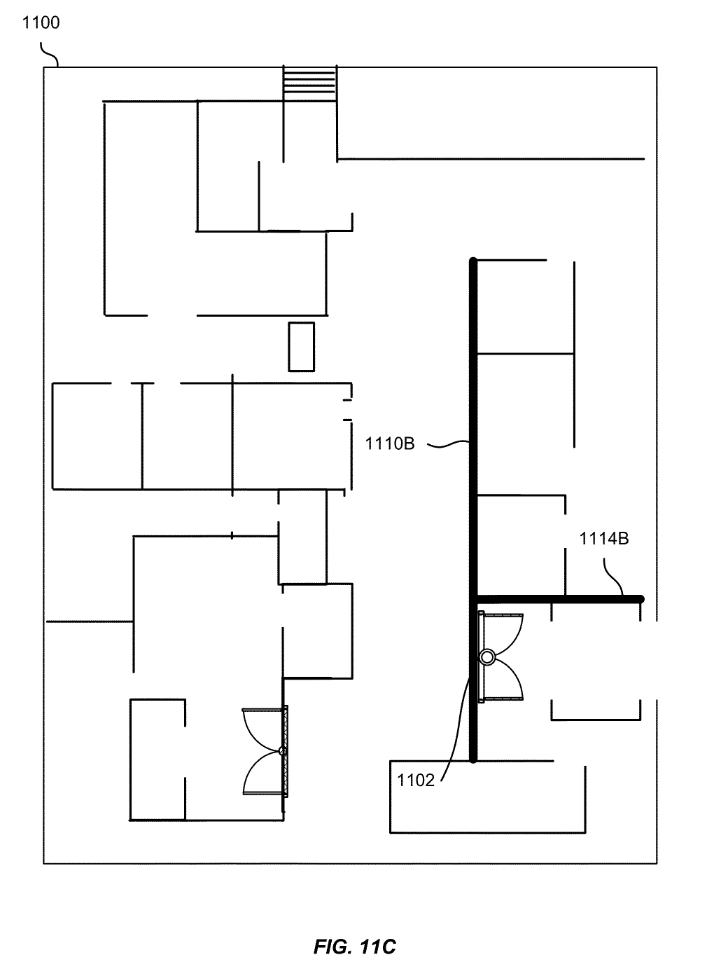

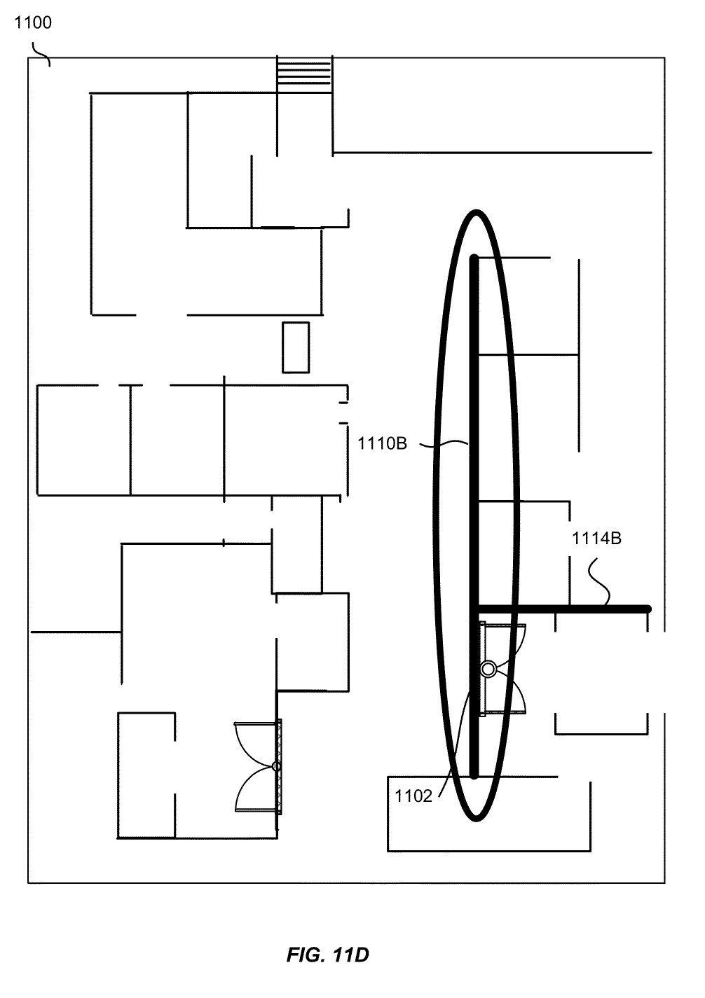

Referring to FIG. 11A, some embodiments may also include analyzing a map and determining which lines on the map represent hallway regions, and/or which lines represent rooms. While a human may be able to easily distinguish what areas on a map represent hallways, rooms, and even perhaps doors and stairways, embodiments may be performed by computers and processors, and may therefore require special programming to decipher. Map 1100 shows a hallway region 1104 closest to POI 1102, illustrated by the highlighted area. In addition, a room region 1006 is shown highlighted, roughly representative of the area within the room of POI 1102 within a line of sight of POI 1102. Embodiments may determine which areas, e.g. 1104 or 1106, may represent the hallway region as opposed to a room region. Such identification may also represent a room entrance, delineating between a room and the hallway from which the room may be entered. This may be important, for example, because some embodiments may desire to focus on just hallway regions or just room regions, and not both. Again, while such detection may seem simple to a human, embodiments implemented by non-humans may employ special programming according to descriptions herein in order to accomplish this task.

Referring to FIG. 11B, some embodiments may identify from regions 1104 and 1106 a series of edges that represent candidates for the hallway edge of POI 1102. By using statistical image analysis or other techniques apparent to persons of ordinary skill in the art, edges such as edges 1110, 1112, 1114, 1116, 1118, and 1120 may be identified based on the regions 1104 and 1106, not shown. An example process may be as follows. First, the hallway region may be identified as the largest connected region within the map boundary, or as pixels with highest connectivity (for reference, please see U.S. Non-Provisional application Ser. No. 13/572,561, filed Aug. 10, 2012, and U.S. Provisional Application 61/550,316, filed Oct. 21, 2011 which are incorporated by reference herein in their entirety for all purposes). Using an edge detection method such as Hough Transform, edges around a POI can be determined One may notice that the highlighted edges 1120, 1110, 1112, 1114, and 1116, for example, are straight lines and do not follow completely the contours of the walls of the map. It may be seen therefore, that such edges are expressed as approximations of the contours and/or walls of a map, with a focus toward identifying which is the hallway edge of the POI 1102.

Referring to FIG. 11C, some embodiments may then compute a rank analysis of each of the identified edges, e.g. edges 1110, 1112, 1114, etc. A rank analysis of each edge may include a calculation based on at least one edge characteristic, e.g. length of the edge, distance of the edge to the POI, and so forth. Each characteristic may be given an appropriate weight, and a score may be determined based on the sum of the values of each characteristic, with each characteristic being proportioned according to a weight factor. Here, edges 1110 and 1114 may be determined to be the two edges with the highest rank analysis scores. Their scores may be based on the lengths of edges 1110B and 1114B, respectively, as shown. Qualitatively, one may determine that it is reasonable to conclude that edges 1110B and 1114B are in fact the two edges with the highest rank analysis scores, based on their lengths and their proximity to POI 1102.

Referring to FIG. 11D, edge 1110B may be determined to be the hallway edge, based on being the highest ranked edge out of all of the edges. This ranking can be determined by a computer and based on the length of the line and the distance from the closest point of the line to the POI. For example, referring to FIG. 11B, based on the length of the lines, edges may be ranked from high to low as 1110, 1112, 1118, 1114, 1116, 1120. Based on distances from the closest point of the line to the POI, edges may be ranked from high to low as 1110, 1118, 1114, 1116, 1112 and 1120. The hallway edge for this POI 1102 may be identified as the edge line 1110B with the highest combine score, which is circled in FIG. 11D. Having determined edge 1110B to be the hallway edge, it may also now be determined what is the orientation of POI 1102, e.g. which direction faces a room, and which direction faces a hallway. Embodiments may determine a hallway by identifying which side of hallway edge 1110B contains a larger area of the visibility map. Additionally, if POI 1102 if a storefront sign, for example, it may now be determined which way the storefront sign is facing, e.g. towards the hallway as opposed to facing inside the room.

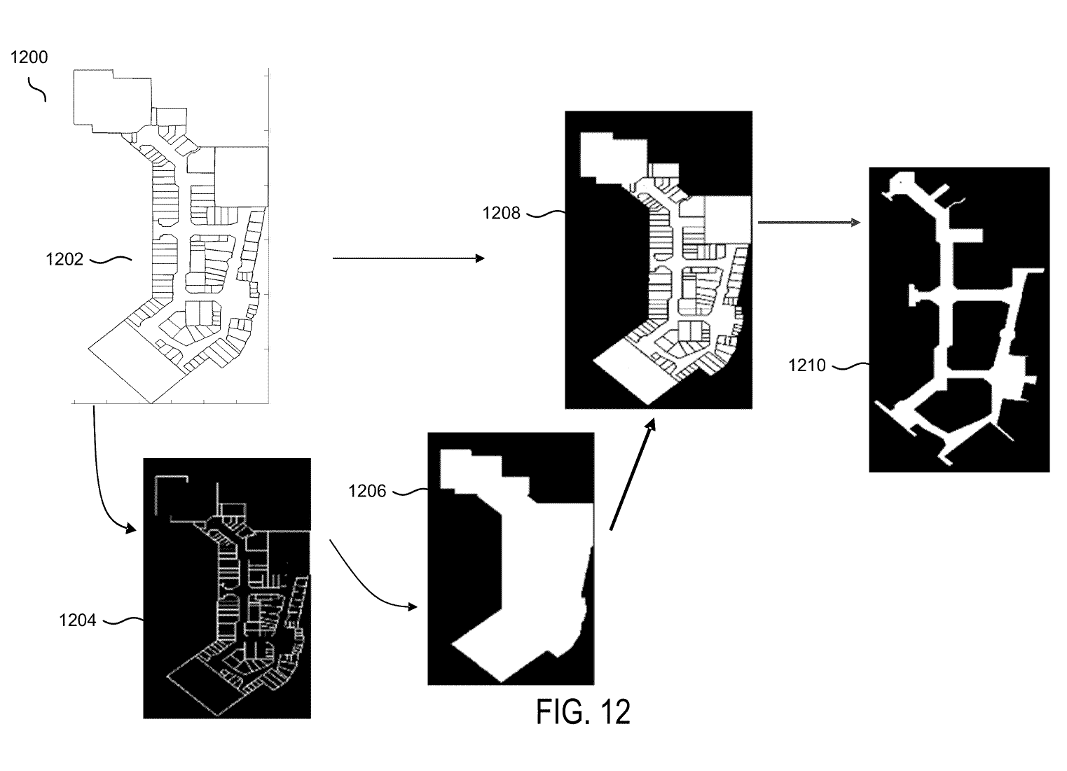

Referring to FIG. 12, embodiments may determine the hallway portion of a map in alternative methods to those described in FIGS. 11A-11D. In some maps, doors of rooms may not be shown, or the doors of rooms may be drawn closed, resulting in maps looking like a series of closed boxes. Flowchart 1200 represents an exemplary method for determining a hallway region for maps that may contain such rooms without doors. Map 1202 is one such map, for example, containing boxes representative of rooms and a hallway region running throughout the rooms. Map 1202 may be an example map of a shopping mall, similar to maps that may be seen on shopping mall kiosks to help shoppers learn where they and the stores reside.

Referring to maps 1204 and 1206, map 1202 may be transformed into a region mask, or a silhouette using various morphological operations. From map 1202 to map 1204, embodiments may first convert the lines (which represent walls) in a map (as black and white binary image) into white, then apply a morphological operation to turn all the black regions enclosed within white areas as black holes into white by filling black holes in the input image. A black/white hole may be a set of black/white pixels that cannot be reached by filling in the black/white pixels from the edge of the image. The mask of the actual building region shown as 1206 can then be determined These steps isolate the indoor space of the map. Then, at map 1208, shapes are extracted from the indoor space, determined by the enclosed regions. That is, for all the areas within the building mask 1206, embodiments may fill all white regions enclosed within black areas as white holes with black.

Then, at map 1210, the hallway region is obtained by choosing the longest and/or largest connected white region of the enclosed spaces, and/or the region with the largest computed area, height, or width. This may be visually verified by comparing map 1208 with map 1210. It can be seen that each room is smaller than the collective area of the hallway space as shown in map 1210.

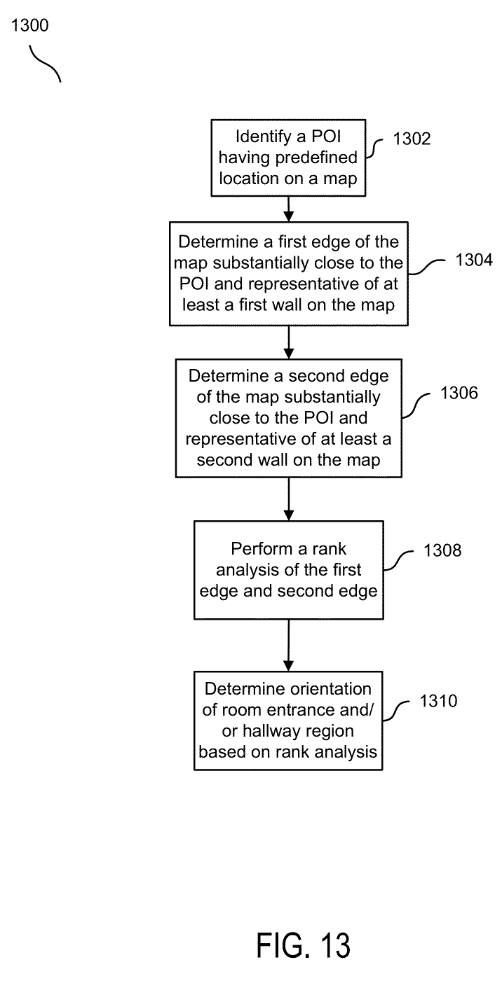

Referring to FIG. 13, flowchart 1300 illustrates methods of some embodiments related to determining a hallway orientation of a POI. The steps described in FIG. 13 may be implemented by any number of devices or apparatuses, including but not limited to mobile devices, computer servers, remote terminals, base stations, and position-determining entities.

Starting at block 1302, embodiments may identify a POI, e.g. POI 1102, not shown, having a predefined location on a map. Any of the POIs mentioned in the present disclosure may suffice, though embodiments are not so limited. The POI may be pre-located on a map such as an overhead map shown in any of the figures of the present disclosure, but embodiments are not so limited. Alternatively, the map may be a 3-dimensional map, illustrating locations in spatial dimensions or at least in multiple levels.

At block 1304, embodiments may determine a first edge of the map close to the POI and representative of at least a first wall on the map. For example, embodiments may perform the descriptions according to FIG. 11B. The first edge may be any of the edges, for example, edges 1110, 1112, 11114, 1116, 1118, or 1120, which may be close to POI 1102 and are representative of at least a first wall on map 1100. Certainly, other edges may be chosen, and embodiments are not so limited.

At block 1306, embodiments may determine a second edge of the map close to the POI and representative of at least a second wall on the map. The second edge may be any of the edges, for example, edges 1110, 1112, 11114, 1116, 1118, or 1120, which may be close to POI 1102 and are representative of at least a second wall on map 1100. Certainly, other edges may be chosen, and embodiments are not so limited. In some embodiments, the first and second edges, representative of at least first and second walls, respectively, are distinct edges and distinct walls, respectively.

At block 1308, embodiments may perform a rank analysis of the first edge and the second edge. For example, embodiments may perform the descriptions according to FIG. 11C. The rank analysis may include a calculation based on at least one edge characteristic, e.g. length of the edge, distance of the edge to the POI, and so forth. Each characteristic may be given an appropriate weight, and a score may be determined based on the sum of the values of each characteristic, with each characteristic being proportioned according to a weight factor. For example, the rank analysis may be a calculation based on the equation R(X)=a*L(X)+b*D(X), where R(X) is the rank score of edge X, L(X) is the length of edge X, D(X) is the distance of edge X from the POI in question, and a and b are weighting constants.

At block 1310, embodiments may then determine an orientation of a room entrance and/or hallway region of the POI based on the rank analysis. For example, embodiments may perform the descriptions according to FIG. 11D. Embodiments may determine which one of the edges is the hallway edge according to which of the edges received the highest rank analysis score. Having determined which edge is the hallway edge, the room/hallway orientation of the POI may be determined based on which side of hallway edge contains a larger area of a visibility map of the POI. It may be decided that the side of the hallway edge that contains the larger area of the visibility map is the hallway region.

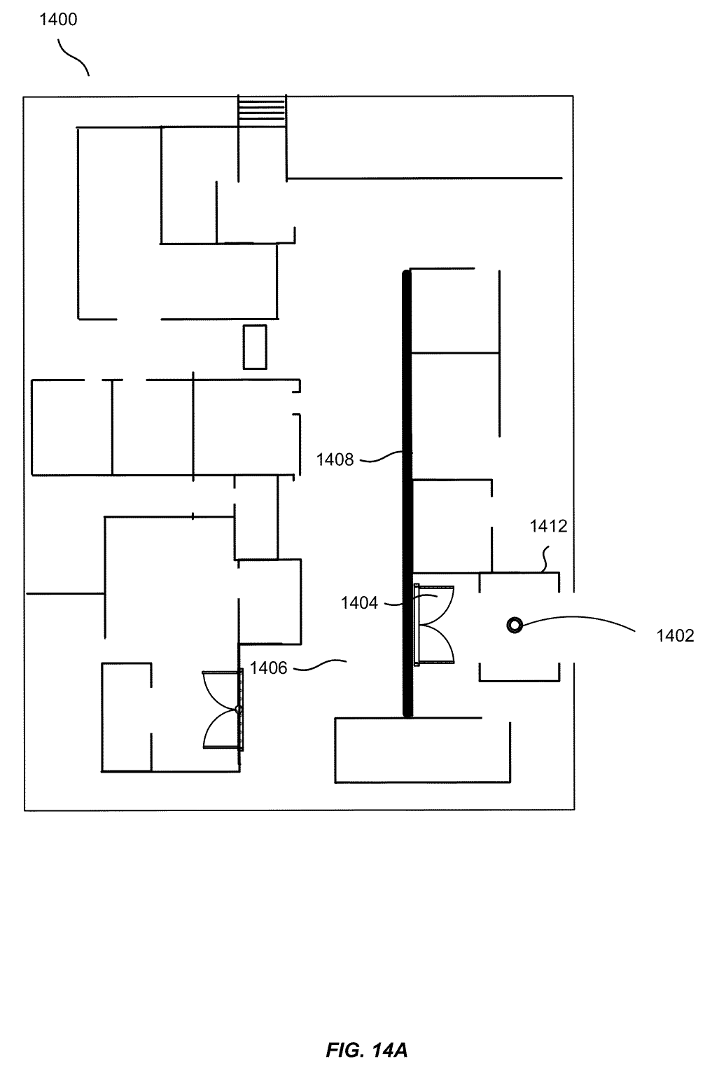

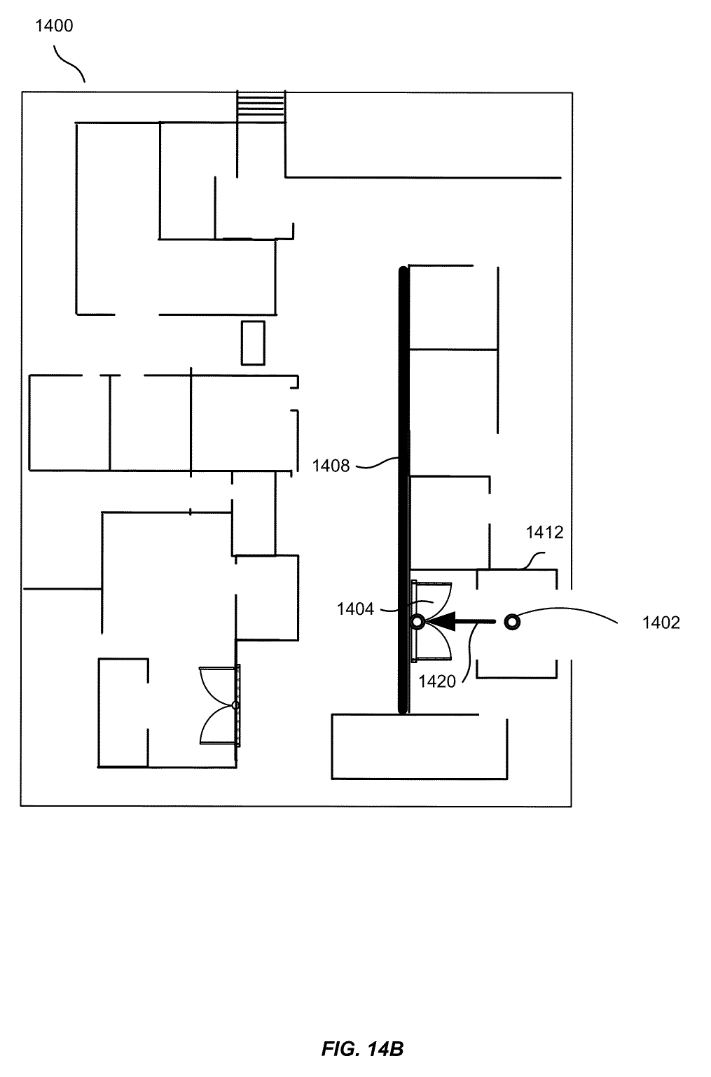

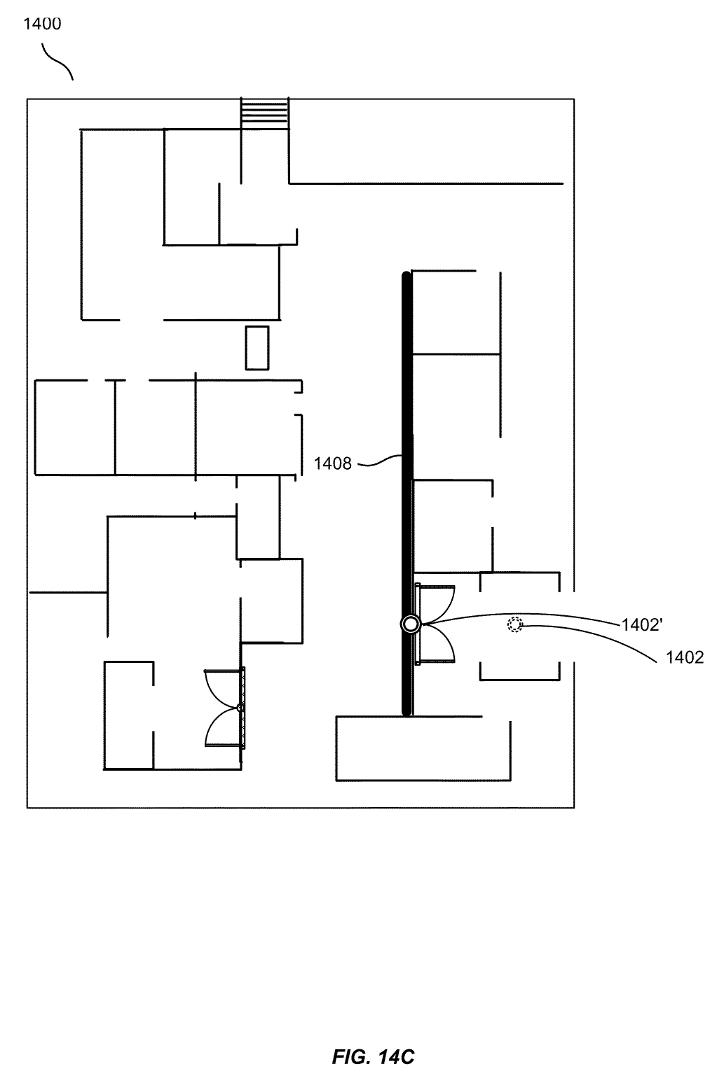

Referring to FIG. 14A, some embodiments may modify the position of a POI on a map, from its predefined location to a new location on the map. POIs may be representative of storefront signs, office room numbers, and other distinguishing marks found indoors. However, some embodiments may receive POIs whose locations reflect other information, such as the general location of a store or a room. For example, a query to a location of the store of “Macy's™” may initially yield the location of the center of the store, not of the storefront. In such cases, when a user standing in a hallway identifies “Macy's™” based on the fact he is standing in front of the store, a POI location of “Macy's™” being located in the center of the store will not reflect an accurate location if visibility maps are based on such a POI being located in the center of the store.

Similarly, POI 1402 may represent such a scenario, where POI 1402 may be located in the middle of room 1412 of map 1400 in FIG. 14A. A user, such as user 102, not shown, may be standing in the hallway region 1406, looking at the room 1412 through doorway 1404. Hence, POI 1402 should be located at doorway 1404, but currently POI 1402 is not. The consequences of POI 1402 not residing at the storefront edge, e.g. at hallway edge 1408 within doorway 1404, may be that visibility maps generated from POI 1402 may appear very narrow and limited. For example, POI 1402 being currently located within the room may yield a visibility map including just the area within the room and a narrow portion of the hallway. Such a visibility map may not accurately reflect all areas that are within a line of sight of the storefront, thereby distorting the true areas where a user may be located. It may therefore be desirable in some embodiments to modify the location of POI 1402, for example recalculating POI 1402 to be located on hallway edge 1408 within doorway 1404.

Referring to FIG. 14B, some embodiments may modify the location of POI 1402 by computing a normal vector 1420, from POI 1402, to hallway edge 1408. The normal vector 1420, as the term implies, may be a line or vector perpendicular to hallway edge 1408 and intersecting POI 1402. Thus, one may appreciate that the location at which normal vector 1420 intersects hallway edge 1408 is the closest point on hallway edge 1408 to POI 1402. Some embodiments therefore may modifying the location of POI 1402 to be on the hallway edge 1408 at the point closest to the original location of POI 1402.

Referring to FIG. 14C, embodiments may finish modifying the location of POI 1402 by recalculating the new location of POI 1402, e.g. POI 1402′. POI 1402′ may be located based on the closest point on hallway edge 1408 to original location of POI 1402.

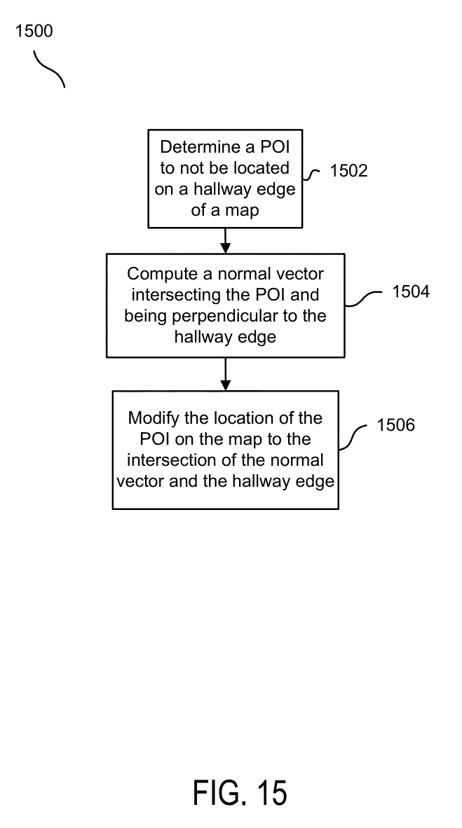

Referring to FIG. 15, flowchart 1500 illustrates methods of some embodiments related to modifying the location of a POI on a map. The steps described in FIG. 15 may be implemented by any number of devices or apparatuses, including but not limited to mobile devices, computer servers, remote terminals, base stations, and position-determining entities.

At block 1502, embodiments may determine that a POI, e.g. POI 1402, is not located on a hallway edge of a map. Any of the POIs mentioned in the present disclosure may suffice, though embodiments are not so limited. The POI may be pre-located on a map such as an overhead map shown in any of the figures of the present disclosure, but embodiments are not so limited. Alternatively, the map may be a 3-dimensional map, illustrating locations in spatial dimensions or at least in multiple levels. POI 1402 may be located inside a room area of a map, rather than on a hallway edge, for example. Block 1502 may be consistent with descriptions in FIG. 14A.

At block 1504, embodiments may compute a normal vector intersecting the POI and being perpendicular to the hallway edge. Block 1504 may be consistent with descriptions in FIG. 14B. In some embodiments, the vector may not be normal or perpendicular to the hallway edge, but may be computed to intersect the hallway edge and the POI at another point. In some embodiments, the vector may be directed to the midpoint of the hallway edge, or to the midpoint of a doorway region, e.g. doorway 1404, not shown, lying on the hallway edge.

In some embodiments, the hallway edge may not be known. In these cases, embodiments may perform methods described in FIGS. 11A-13, so that the hallway edge may be computed. In other cases, embodiments may have the hallway edge predefined on the map, or other methods may be used to identify the hallway edge. Embodiments are not so limited.

At block 1506, embodiments may modify the location of the POI on the map to be at the intersection of the normal vector and the hallway edge. Block 1506 may be consistent with descriptions in FIG. 14C. Where the normal vector 1420 is computed as the line starting at the given (i.e. premodified) POI 1402 and drawn perpendicular to the identified hallway line 1404, the intersection between the normal vector 1420 and the hallway line 1405 is the modified POI location 1402′, and may be designated as the access point to the store or room.

Many embodiments may be made in accordance with specific requirements. For example, customized hardware might also be used, and/or particular elements might be implemented in hardware, software (including portable software, such as applets, etc.), or both. Further, connection to other computing devices such as network input/output devices may be employed.

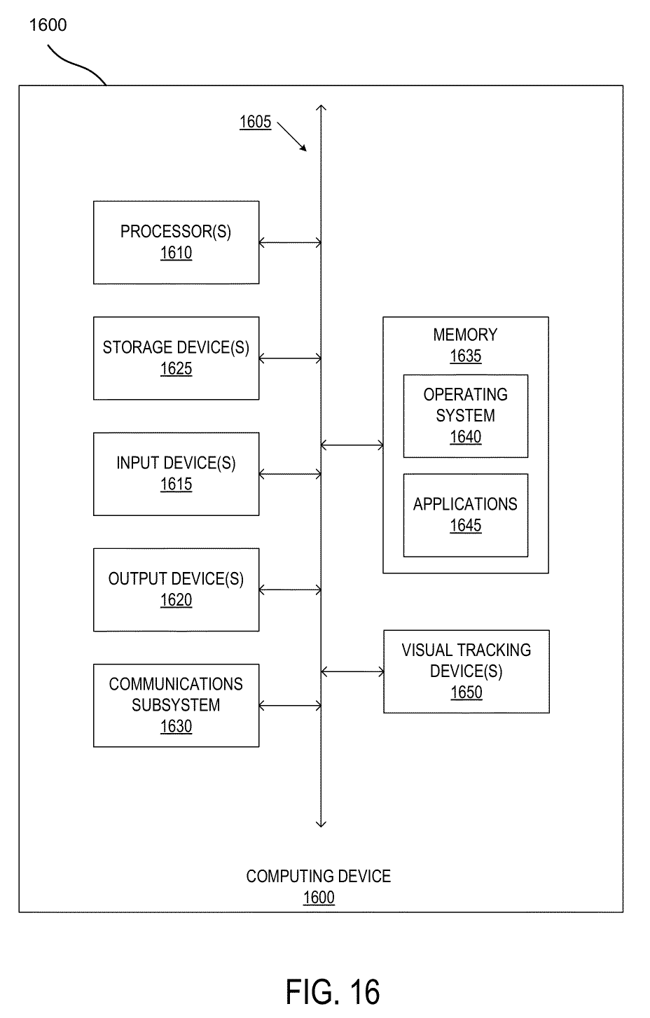

Having described multiple aspects of position location determination using map analysis, an example of a computing system in which various aspects of the disclosure may be implemented will now be described with respect to FIG. 16. According to one or more aspects, a computer system as illustrated in FIG. 16 may be incorporated as part of a computing device, which may implement, perform, and/or execute any and/or all of the features, methods, and/or method steps described herein. For example, computer system 1600 may represent some of the components of a hand-held device. A hand-held device may be any computing device with an input sensory unit, such as a camera and/or a display unit. Examples of a hand-held device include but are not limited to video game consoles, tablets, smart phones, televisions, and mobile devices. In one embodiment, the system 1600 is configured to implement any of the methods described above. FIG. 16 provides a schematic illustration of one embodiment of a computer system 1600 that can perform the methods provided by various other embodiments, as described herein, and/or can function as the host computer system, a remote kiosk/terminal, a point-of-sale device, a mobile device, a set-top box, and/or a computer system. FIG. 16 is meant only to provide a generalized illustration of various components, any and/or all of which may be utilized as appropriate. FIG. 16, therefore, broadly illustrates how individual system elements may be implemented in a relatively separated or relatively more integrated manner.

The computer system 1600 is shown comprising hardware elements that can be electrically coupled via a bus 1605 (or may otherwise be in communication, as appropriate). The hardware elements may include one or more processors 1610, including without limitation one or more general-purpose processors and/or one or more special-purpose processors (such as digital signal processing chips, graphics acceleration processors, and/or the like); one or more input devices 1615, which can include without limitation a camera, wireless receivers, wireless sensors, a mouse, a keyboard and/or the like; and one or more output devices 1620, which can include without limitation a display unit, a printer and/or the like. In some embodiments, the one or more processor 1610 may be configured to perform a subset or all of the functions described above with respect to FIGS. 8, 10, 13, and/or 15. The processor 1610 may comprise a general processor and/or and application processor, for example. In some embodiments, the processor is integrated into an element that processes visual tracking device inputs and wireless sensor inputs.

The computer system 1600 may further include (and/or be in communication with) one or more non-transitory storage devices 1625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 1600 might also include a communications subsystem 1630, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 1630 may permit data to be exchanged with a network (such as the network described below, to name one example), other computer systems, and/or any other devices described herein. In many embodiments, the computer system 1600 will further comprise a non-transitory working memory 1635, which can include a RAM or ROM device, as described above.

The computer system 1600 also can comprise software elements, shown as being currently located within the working memory 1635, including an operating system 1640, device drivers, executable libraries, and/or other code, such as one or more application programs 1645, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIGS. 8, 10, 13, and/or 15, might be implemented as code and/or instructions executable by a computer (and/or a processor within a computer); in an aspect, then, such code and/or instructions can be used to configure and/or adapt a general purpose computer (or other device) to perform one or more operations in accordance with the described methods. The processor 1610, memory 1635, operating system 1640, and/or application programs 1645 may comprise a gesture detection engine, as discussed above, and/or may be used to implement any or all of blocks described with respect to FIGS. 8, 10, 13, and/or 15.

A set of these instructions and/or code might be stored on a computer-readable storage medium, such as the storage device(s) 1625 described above. In some cases, the storage medium might be incorporated within a computer system, such as computer system 1600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1600 and/or might take the form of source and/or installable code, which, upon compilation and/or installation on the computer system 1600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 1600) to perform methods in accordance with the disclosure. For example, some or all of the procedures of the described methods may be performed by the computer system 1600 in response to processor 1610 executing one or more sequences of one or more instructions (which might be incorporated into the operating system 1640 and/or other code, such as an application program 1645) contained in the working memory 1635. Such instructions may be read into the working memory 1635 from another computer-readable medium, such as one or more of the storage device(s) 1625. Merely by way of example, execution of the sequences of instructions contained in the working memory 1635 might cause the processor(s) 1610 to perform one or more procedures of the methods described herein, for example methods described with respect to FIGS. 8, 10, 13, and/or 15.

The terms “machine-readable medium” and “computer-readable medium,” as used herein, refer to any medium that participates in providing data that causes a machine to operate in a specific fashion. In an embodiment implemented using the computer system 1600, various computer-readable media might be involved in providing instructions/code to processor(s) 1610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1625. Volatile media include, without limitation, dynamic memory, such as the working memory 1635. Transmission media include, without limitation, coaxial cables, copper wire and fiber optics, including the wires that comprise the bus 1605, as well as the various components of the communications subsystem 1630 (and/or the media by which the communications subsystem 1630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1600. These signals, which might be in the form of electromagnetic signals, acoustic signals, optical signals and/or the like, are all examples of carrier waves on which instructions can be encoded, in accordance with various embodiments of the invention.

The communications subsystem 1630 (and/or components thereof) generally will receive the signals, and the bus 1605 then might carry the signals (and/or the data, instructions, etc. carried by the signals) to the working memory 1635, from which the processor(s) 1610 retrieves and executes the instructions. The instructions received by the working memory 1635 may optionally be stored on a non-transitory storage device 1625 either before or after execution by the processor(s) 1610. Also, visual tracking device 1650 may record and/or identify POIs according to methods described in any or all of FIGS. 8, 10, 13, and/or 15. Visual tracking device 1650 may receive or detect data of POIs, for example signals from POIs that identify computing device is near a POI. Alternatively, visual tracking device 1650 may capture an image of a POI. Data from visual tracking device 1650 may be inputs into processor(s) 1610, whereby processor(s) 1610 may then perform methods described herein.

The methods described in FIGS. 8, 10, 13, and/or 15 may be implemented by various blocks in FIG. 16. For example, processor 1610 may be configured to perform any of the functions of blocks in diagram 800, blocks in diagram 1000, blocks in diagram 1300 and blocks in diagram 1500. Storage device 1625 may be configured to store an intermediate result, such as a recorded object or image used for tracking purposes within any of blocks mentioned herein. The memory 1635 may similarly be configured to record an image or object necessary to perform any of the functions described in any of the blocks mentioned herein. Results that may need to be stored in a temporary or volatile memory, such as RAM, may also be included in memory 1635, and may include any intermediate result similar to what may be stored in storage device 1625. Input device 1615 may be configured to accept an input from a camera, visual display, or other peripheral described in any of FIGS. 1-15. Output device 1620 may be configured to output an image or series of images as described in any of FIGS. 1-15, and/or a tracking result that is an output of block 1650.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method of determining an orientation of a room entrance on a map, the method comprising:
identifying a point of interest (POI) on the map indicative of the room entrance;
determining a first edge of the map close to the POI and representative of at least a first wall on the map;
determining a second edge of the map close to the POI and representative of at least a second wall on the map;
performing a rank analysis of the first edge and second edge based on at least one characteristic of the first edge and one characteristic of the second edge; and
determining the orientation of the room entrance based at least in part on the rank analysis.

2. The method of claim 1, wherein performing the rank analysis is further based on the length of the first edge and the length of the second edge.

3. The method of claim 1, wherein performing the rank analysis is further based on the distance of the first edge to the POI and the distance of the second edge to the POI.

4. The method of claim 1, wherein performing the rank analysis comprises:
computing a rank score of the first edge and a rank score of the second edge; and
selecting the first edge if the rank score of the first edge is higher than the rank score of the second edge, or selecting the second edge if the rank score of the second edge is higher than the rank score of the first edge.

5. A method for determining a hallway region of a map, the method comprising:
receiving a map;
identifying a plurality of regions on the map being enclosed on all sides by one or more lines; and
determining the region from the plurality of regions having a largest dimensional characteristic amongst the plurality of regions to be the hallway region of the map.

6. The method of claim 5, wherein the dimensional characteristic is total area of the region.

7. The method of claim 5, wherein the dimensional characteristic is longest length of the region.

8. A method of modifying the location a point of interest (POI) on a map, comprising:
determining that the POI is not located on a hallway edge of the map;
computing a vector intersecting the POI and intersecting the hallway edge; and
modifying the location of the POI on the map to the intersection of the vector and the hallway edge.

9. The method of claim 8 wherein the vector is a normal vector perpendicular to the hallway edge.

10. The method of claim 9, further comprising modifying the location of the POI to the intersection of the normal vector and the hallway edge.

11. An apparatus for determining an orientation of a room entrance on a map, the apparatus comprising a processor configured to:
identify a point of interest (POI) on the map indicative of the room entrance;
determine a first edge of the map close to the POI and representative of at least a first wall on the map;
determine a second edge of the map close to the POI and representative of at least a second wall on the map;
perform a rank analysis of the first edge and second edge based on at least one characteristic of the first edge and one characteristic of the second edge; and
determine the orientation of the room entrance based at least in part on the rank analysis.

12. The apparatus of claim 11, wherein the processor is further configured to perform the rank analysis further based on the length of the first edge and the length of the second edge.

13. The apparatus of claim 11, wherein the processor is further configured to perform the rank analysis further based on the distance of the first edge to the POI and the distance of the second edge to the POI.

14. The apparatus of claim 11, wherein the processor is further configured to:
compute a rank score of the first edge and a rank score of the second edge; and
select the first edge if the rank score of the first edge is higher than the rank score of the second edge, or selecting the second edge if the rank score of the second edge is higher than the rank score of the first edge.

15. An apparatus for determining an orientation of a room entrance on a map, the apparatus comprising:
means for identifying a point of interest (POI) on the map indicative of the room entrance;
means for determining a first edge of the map close to the POI and representative of at least a first wall on the map;
means for determining a second edge of the map close to the POI and representative of at least a second wall on the map;
means for performing a rank analysis of the first edge and second edge based on at least one characteristic of the first edge and one characteristic of the second edge; and
means for determining the orientation of the room entrance based at least in part on the rank analysis.

16. The apparatus of claim 15, wherein means for performing the rank analysis is further based on the length of the first edge and the length of the second edge.

17. The apparatus of claim 15, wherein means for performing the rank analysis is further based on the distance of the first edge to the POI and the distance of the second edge to the POI.

18. The apparatus of claim 15, wherein means for performing the rank analysis comprises:
means for computing a rank score of the first edge and a rank score of the second edge; and
means for selecting the first edge if the rank score of the first edge is higher than the rank score of the second edge, or selecting the second edge if the rank score of the second edge is higher than the rank score of the first edge.

19. A computer program product residing on a processor-readable medium and comprising processor-readable instructions configured to cause a processor to:
identify a point of interest (POI) on the map indicative of the room entrance;
determine a first edge of the map close to the POI and representative of at least a first wall on the map;
determine a second edge of the map close to the POI and representative of at least a second wall on the map;
perform a rank analysis of the first edge and second edge based on at least one characteristic of the first edge and one characteristic of the second edge; and
determine the orientation of the room entrance based at least in part on the rank analysis.

20. The computer program product of claim 19, wherein the processor-readable instructions further cause the processor to perform the rank analysis further based on the length of the first edge and the length of the second edge.

21. The computer program product of claim 20, wherein the processor-readable instructions further cause the processor to perform the rank analysis further based on the distance of the first edge to the POI and the distance of the second edge to the POI.

22. The computer program product of claim 19, wherein the processor-readable instructions further cause the processor to:
compute a rank score of the first edge and a rank score of the second edge; and
select the first edge if the rank score of the first edge is higher than the rank score of the second edge, or selecting the second edge if the rank score of the second edge is higher than the rank score of the first edge.
